(19) United States
(12) Patent Application Publication
(10) Pub. No.: US 2026/0087351 A1
(43) Pub. Date: Mar. 26, 2026

(54) VIDEO TOKENIZATION USING CHANNEL-SPLIT QUANTIZATION AND MAMBA-BASED TOKENIZER MODELS

(71) Applicant: NVIDIA CORPORATION, Santa Clara, CA (US)

(72) Inventors: Dawit Mureja ARGAW, Daejeon (KR); Fitsum REDA, Santa Clara, CA (US); Ming-Yu LIU, Redwood City, CA (US)

(21) Appl. No.: 19/301,848

(22) Filed: Aug. 15, 2025

Related U.S. Application Data
(60) Provisional application No. 63/698,483, filed on Sep. 24, 2024.

(51) Int. Cl. G06N 3/0895; G06N 3/0455; G06T 3/4007; G06T 3/4046

(52) U.S. Cl. CPC G06N 3/0895; G06N 3/0455; G06T 3/4007; G06T 3/4046

(57) ABSTRACT

The disclosed method for tokenizing video frames includes receiving one or more video frames from one or more I/O devices, generating, using an encoder, one or more latent embeddings based on the one or more video frames, wherein the encoder comprises one or more patchify modules, one or more spatial-temporal Mamba modules, and one or more token pooling modules, and generating, using a quantizer, one or more quantized latent embeddings based on the one or more latent embeddings.

### CROSS-REFERENCE TO RELATED APPLICATIONS

This application claims priority benefit of the U.S. Provisional Patent Application titled, “CHANNEL SPLIT QUANTIZATION FOR DISCRETE VIDEO TOKENIZATION,” filed on Sep. 24, 2024, and having Ser. No. 63/698,483. The subject matter of this related application is hereby incorporated herein by reference.

### BACKGROUND

### Technical Field

Embodiments of the present disclosure relate generally to computer science, artificial intelligence and machine learning, and, more specifically, to video tokenization using channel-split quantization and Mamba-based tokenizer models.

### Description of the Related Art

Video generation refers to the process of synthesizing sequences of image frames that collectively form a coherent and temporally consistent video. Video generation lies at the intersection of computer vision and generative modeling and has broad applications in entertainment, simulation, robotics, virtual reality, creative content creation, and/or the like. Video generation aims to produce visually realistic and semantically meaningful motion across time, often conditioned on external signals, such as text descriptions, audio, keyframes, and/or the like. An important step in many modern video generation pipelines is video tokenization, which transforms continuous spatiotemporal input data into discrete representations referred to as the tokenized forms. The tokenized forms enable scalable training of generative models, such as autoregressive transformers, diffusion models, and/or the like, by converting high-dimensional video frames into compact, symbolic units that can be modeled as discrete sequences. Video tokenization facilitates learning long-range dependencies, supports efficient compression, and allows modular integration of components, such as encoders, quantizers, and decoders. The ability to generate video from discrete sequences (e.g., tokens) opens a wide range of applications, including but not limited to data-efficient video synthesis, controllable animation, compact transmission and sharing, such as video streaming, and generative pretraining for multimodal tasks.

Conventional approaches to video tokenization typically employ a two-stage pipeline that includes a tokenization step followed by generative modeling over the resulting tokens. In the tokenization stage, video frames are processed by an encoder to extract spatiotemporal embeddings, which are then quantized using approaches, such as vector quantization (VQ) and/or the like, with a learnable codebook. The resulting tokens represent visual and motion patterns in a compact form and serve as the modeling target for subsequent generative components. In the generation stage, an autoregressive or transformer-based model is trained to predict sequences of tokens conditioned on preceding tokens and/or external conditions, enabling coherent synthesis of video content over time. For example, approaches such as VideoGPT and/or the like adopt convolutional or attention-based architectures to model the temporal progression of token sequences and generate plausible future video frames. Conventional approaches for video generation often operate on fixed-length patches extracted from video inputs, and the decoder reconstructs pixel-level video frames from predicted tokens using learned dequantization and decoding networks.

One drawback of conventional approaches for video tokenization is the reliance on fixed codebook quantization, such as VQ, which introduces challenges in training stability, efficiency, and representation quality. For example, VQ techniques require the use of a learnable codebook to discretize high-dimensional embeddings, but training the codebook can be unstable and often requires additional losses and hyperparameter tuning. In addition, large codebooks tend to be underutilized, reducing token diversity and thereby limiting generative performance. Computational inefficiency also arises from the need to perform nearest-neighbor searches across all codebook entries during encoding. Other examples of quantization approaches include look-up free quantization (LFQ) and finite scalar quantization (FSQ) which include non-learnable, deterministic mappings. However, LFQ and FSQ constrain latent expressiveness. For example, LFQ restricts values to binary representations, while FSQ limits the latent space to small fixed-value sets-forcing decoder networks to compensate during reconstruction and potentially limiting generalization capability in diverse video generation tasks.

Another drawback of conventional approaches for video tokenization is the patch-based tokenization. Conventional approaches for video tokenization often include encoder-decoder architectures that process video frames at fixed resolutions and do not fully exploit the hierarchical or adaptive structure of natural video content, which can lead to inefficiencies in modeling large-scale motion or scene transitions, especially when generating high-fidelity videos over extended durations.

As the foregoing illustrates, what is needed in the art are more effective techniques for video tokenization.

### SUMMARY

According to some embodiments, a computer-implemented method for tokenizing video frames. The method includes receiving one or more video frames from one or more I/O devices. The method further includes generating, using an encoder, one or more latent embeddings based on the one or more video frames, wherein the encoder comprises one or more patchify modules, one or more spatial-temporal Mamba modules, and one or more token pooling modules. The method also includes generating, using a quantizer, one or more quantized latent embeddings based on the one or more latent embeddings.

Further embodiments provide, among other things, non-transitory computer-readable storage media storing instructions and systems configured to implement the method set forth above.

At least one technical advantage of the disclosed techniques relative to the prior art is that the disclosed techniques improve quantization stability, efficiency, and expressiveness. The disclosed techniques further enable scalable, deterministic tokenization without reliance on a single fixed codebook. In addition, the disclosed techniques provide for more adaptive and context-aware tokenization than prior art methods. The tokens generated by the disclosed techniques also better capture global scene dynamics and long-range motion patterns, supporting efficient and high-fidelity video tokenization over extended temporal spans. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the present disclosure;

FIG. 2 is a block diagram of a parallel processing unit included in the parallel processing subsystem of FIG. 1, according to various embodiments of the present disclosure;

FIG. 3 is a block diagram of a general processing cluster included in the parallel processing unit of FIG. 2, according to various embodiments of the present disclosure;

FIG. 4 is a block diagram of a computer system configured to implement one or more aspects of various embodiments;

FIG. 5A is a more detailed illustration of the tokenizer model of FIG. 4, according to various embodiments;

FIG. 5B is a more detailed illustration of the encoder of FIG. 4, according to various embodiments;

FIG. 5C is a more detailed illustration of the decoder of FIG. 4, according to various embodiments;

FIG. 6 is a more detailed illustration of the quantizer of FIG. 4, according to various embodiments;

FIG. 7 is a more detailed illustration of the model trainer of FIG. 4, according to various embodiments;

FIG. 8 is a more detailed illustration of the video generation application of FIG. 4, according to various embodiments;

FIG. 9 is a flow diagram of method steps for generating reconstructed video frames, according to various embodiments;

FIG. 10 is a flow diagram of method steps for generating latent embeddings based on video frames, according to various embodiments;

FIG. 11 is a flow diagram of method steps for generating quantized latent embeddings based on latent embeddings, according to various embodiments;

FIG. 12 is a flow diagram of method steps for generating reconstructing video frames based on quantized latent embeddings, according to various embodiments;

FIG. 13 is a flow diagram of method steps for training tokenizer model, according to various embodiments; and

FIG. 14 is a flow diagram of method steps for generating generated video frames, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for video tokenization using channel-split quantization and mamba-based tokenizer models. In some embodiments, disclosed techniques include a tokenizer model. The tokenizer model is a machine learning model, such as a neural network, which processes one or more video frames and generates reconstructed video frames. The tokenizer model includes an encoder, a quantizer, and a decoder. The encoder is a machine learning model, such as a neural network, which processes the video frames and generates one or more latent embeddings. The encoder includes a multi-layer hierarchical architecture which includes without limitation one or more patchify modules, token pooling modules, and spatial-temporal Mamba modules arranged in an alternating sequence. The encoder progressively processes input video frames into increasingly abstract token representations, applying spatial and temporal attention at multiple scales to capture both local and long-range dependencies. Through the layered composition, the encoder generates latent embeddings that summarize the spatiotemporal content of the input video in a compressed and semantically rich form.

In some embodiments, the quantizer processes the latent embeddings and generates one or more quantized latent embeddings. The decoder is a machine learning model, such as a neural network, which processes the quantized latent embeddings and generates the reconstructed video frames. The decoder includes a multi-stage architecture, which includes without limitation one or more temporal-spatial Mamba modules, topixel modules, and token interpolation modules arranged in sequential layers. The decoder transforms quantized latent embeddings into reconstructed video frames by progressively refining and upsampling intermediate token representations. Each stage applies spatiotemporal processing followed by token-to-grid conversion and resolution enhancement, enabling high-fidelity reconstruction of video content from discrete tokens. In some embodiments, a model trainer trains the tokenizer model based on video data. During training, the tokenizer model processes the video data and generates the reconstructed video frames. A loss calculator calculates a loss based on the reconstructed video frames and one or more ground-truth video frames included in the video data. The model trainer uses the loss to iteratively update the parameters of the tokenizer model until one or more stopping criteria are met. Once the tokenizer model is trained, a video generation application uses the quantizer and the decoder included in the trained tokenizer model to process one or more conditions and generate generated video frames.

In some embodiments, the tokenizer includes a channel-splitting module, a quantization module, and a concatenation module. The channel-splitting module processes the latent embeddings and generates one or more channel groups. The quantization module processes the channel groups and generates one or more quantized groups. The concatenation module processes the quantized groups and generates the quantized latent embeddings.

The video tokenization techniques of the present disclosure have many real-world applications. For example, the video tokenization techniques could be used in content creation platforms to compress and represent video data in a compact, discrete form that can be efficiently modeled or manipulated. As another example, the video tokenization techniques could be employed in simulation environments to convert video sequences into structured tokens for efficient retrieval, editing, or annotation. The video tokenization techniques could also be used in virtual reality and gaming systems to enable scalable rendering, adaptive content streaming, or context-aware scene generation by leveraging discrete video representations that support downstream generative or interactive tasks. The above examples are not in any way intended to be limiting. As persons skilled in the art will appreciate, as a general matter, the video generation techniques described herein can be implemented in any suitable application.

### System Overview

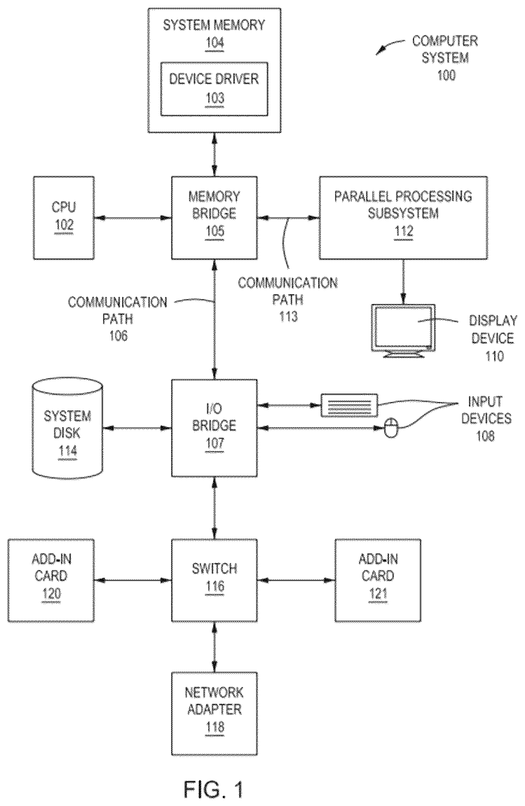

FIG. 1 is a block diagram of a computer system 100 configured to implement one or more aspects of the present disclosure. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

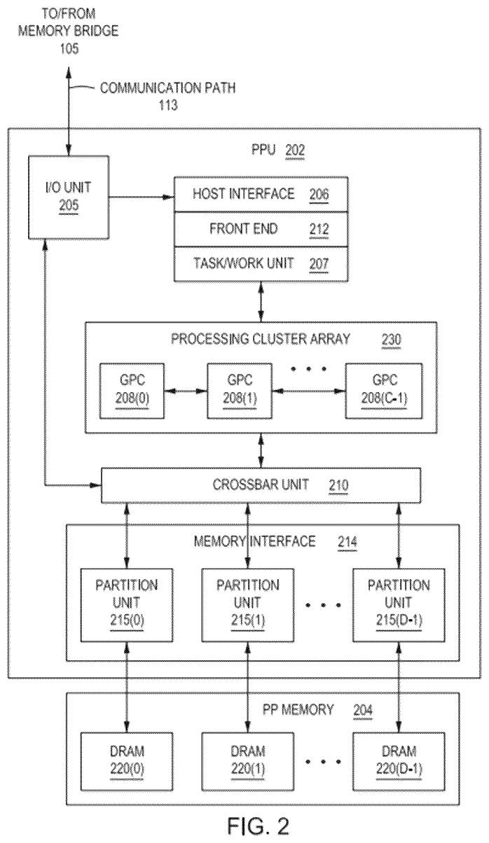

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present disclosure. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D 1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

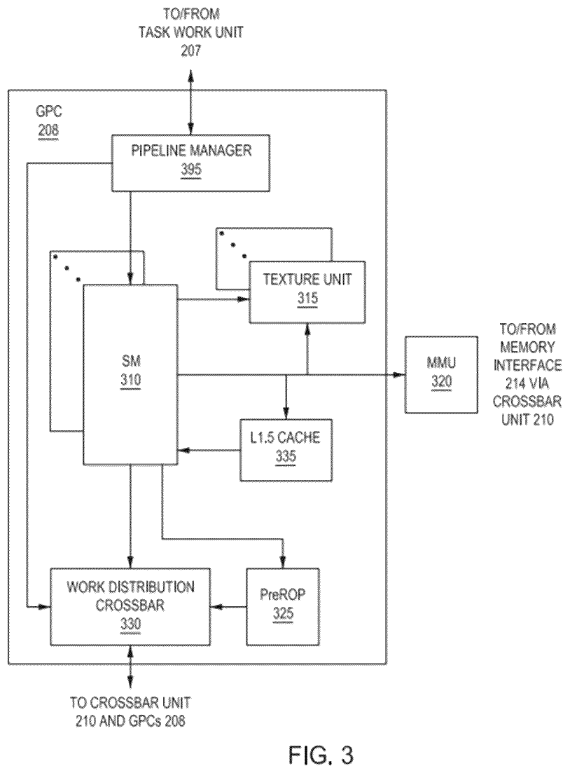

FIG. 3 is a block diagram of a GPC 208 included in PPU 202 of FIG. 2, according to various embodiments of the present disclosure. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present disclosure.

### Video Tokenization Based on the Mamba-Based Tokenizer Model

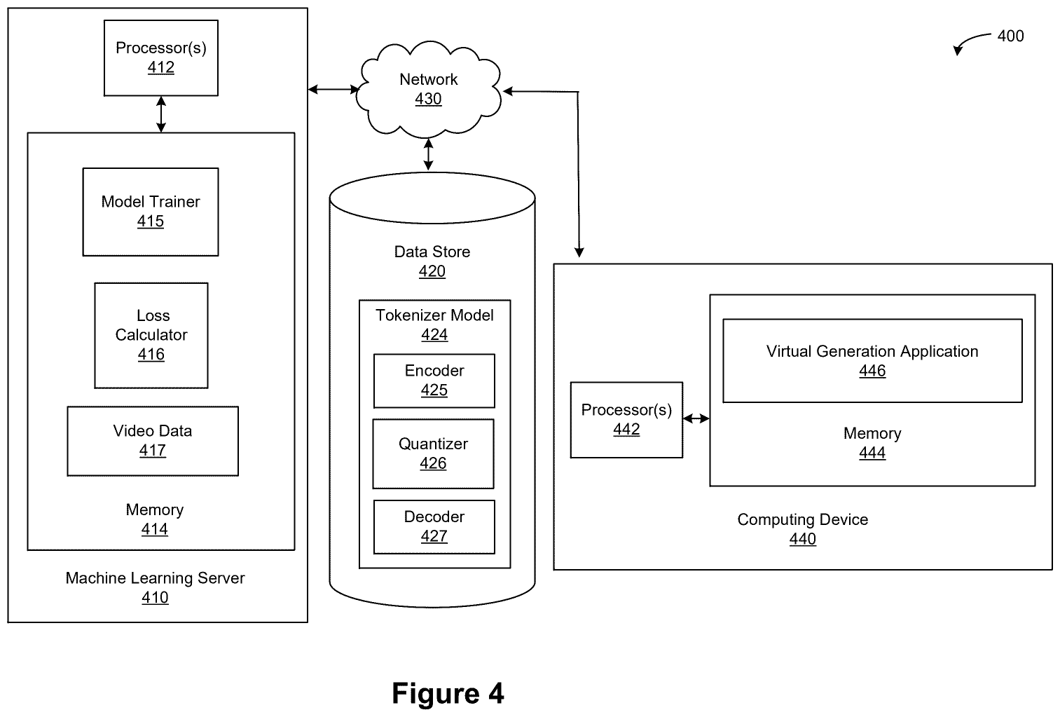

FIG. 4 is a block diagram of a computer system 400 configured to implement one or more aspects of various embodiments. As shown, computer system 400 includes, without limitation, a machine learning server 410, a data store 420, and a computing device 440 in communication over a network 430, which can be a wide area network (WAN) such as the Internet, a local area network (LAN), a cellular network, and/or any other suitable network. Machine learning server 410 includes, without limitation, processor(s) 412 and a memory 414. Memory 414 includes, without limitation, a model trainer 415, a loss calculator 416, and video data 417. Data store 420 includes, without limitation, tokenizer model 424. Tokenizer model 424 includes, without limitation, encoder 425, quantizer 426, and decoder 427. Computing device 440 includes, without limitation, processor(s) 442 and a memory 444. Memory 444 includes, without limitation, video generation application 446.

Processor(s) 412 receive user input from input devices, such as a keyboard or a mouse. Processor(s) 412 may include one or more primary processors of machine learning server 410, controlling and coordinating operations of other system components. In particular, processor(s) 412 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 414 of machine learning server 410 stores content, such as software applications and data, for use by processor(s) 412 and the GPU(s) and/or other processing units. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 414. The storage can include any number and type of external memories that are accessible to processor 412 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 410 shown herein is for illustrative purposes only, and variations and modifications are possible without departing from the scope of the present disclosure. For example, the number of processors 412, the number of GPUs and/or other processing unit types, the number of system memories 414, and/or the number of applications included in memory 414 can be modified as desired. Further, the connection topology between the various units in FIG. 4 can be modified as desired. In some embodiments, any combination of processor(s) 412, memory 414, and/or GPU(s) can be included in and/or replaced with any type of virtual computing system, distributed computing system, and/or cloud computing environment, such as a public, private, or a hybrid cloud system.

As shown, model trainer 415 is an application that executes on the one or more processors 412 of machine learning server 410 and is stored in a system memory 414 of machine learning server 410. Although shown as distinct from loss calculator 416 for illustrative purposes, in some embodiments, functionality of loss calculator 416 and model trainer 415 can be combined into a single application.

In some embodiments, model trainer 415 is configured to train one or more machine learning models, including tokenizer model 424. Tokenizer model 424 is a machine learning model, such as a neural network, which processes one or more video frames and generates the reconstructed video frames. Encoder 425 is a machine learning model, such as a neural network, which processes the video frames and generates one or more latent embeddings. In some embodiments, encoder 425 includes, without limitation, a first patchify module, a first spatial-temporal Mamba module, a second patchify module, a first token pooling module, a second spatial-temporal Mamba module, a third patchify module, a second token pooling module, and a third spatial-temporal Mamba module. The first patchify module processes the video frames and generates one or more first patched tokens. The first spatial-temporal Mamba module processes the first patched tokens and generates one or more processed patched tokens. The second patchify module processes processed patched tokens and generates one or more second patched tokens. The first token pooling module processes the second patched tokens and the processed patched tokens and generates one or more first pooled tokens. The second spatial-temporal Mamba module processes the first pooled tokens and generates one or more processed pooled tokens. The third patchify module processes the processed pooled tokens and generates one or more second patched tokens. The second token pooling module processes the second patched tokens and the processed pooled tokens and generates one or more second pooled tokens. The third spatial-temporal Mamba module processes the second pooled tokens and generates the latent embeddings.

As shown, loss calculator 416 executes on one or more processors 412 of machine learning server 410 and is stored in memory 414 of machine learning server 410. Loss calculator 416 is an application that calculates a loss based on one or more reconstructed video frames and one or more ground-truth video frames included in video data 417. Video data 417 includes sequences of temporally ordered image or video frames representing visual content over time, such as raw or encoded video clips. Video data 417 includes video frames from real-world footage, simulated environments, or user-generated content, and includes annotations or metadata for conditioning or evaluation purposes. In some embodiments, loss calculator 416 uses a combination of loss functions, including but not limited to (i) a reconstruction loss that minimizes the L1 (Manhattan distance) between corresponding pixels of the ground-truth video frames and the reconstructed video frames, (ii) a perceptual loss that computes frame-wise perceptual similarity using the Learned Perceptual Image Patch Similarity (LPIPS) metric between the ground-truth video frames and the reconstructed video frames, and/or (iii) a generative adversarial network (GAN) loss that uses a three-dimensional (3D) convolutional PatchGAN discriminator to differentiate real videos from generated reconstructed video frames. In some embodiments, for certain tokenization strategies included in quantizer 426, such as LFQ, loss calculator 416 includes entropy penalties and commitment losses. In some embodiments, whenever quantizer 426 includes FSQ, loss calculator 416 bypasses explicit codebook loss computation.

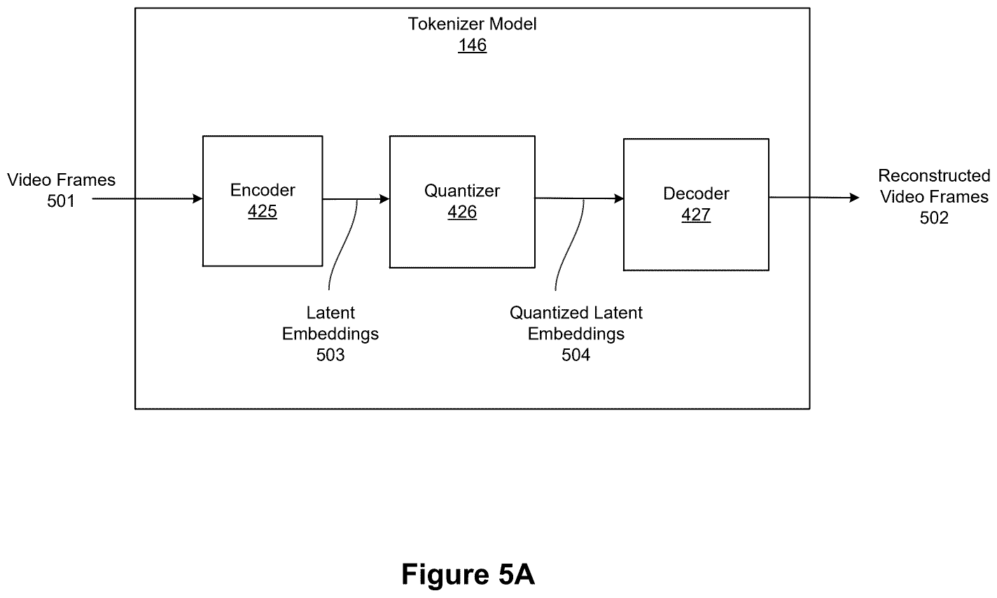

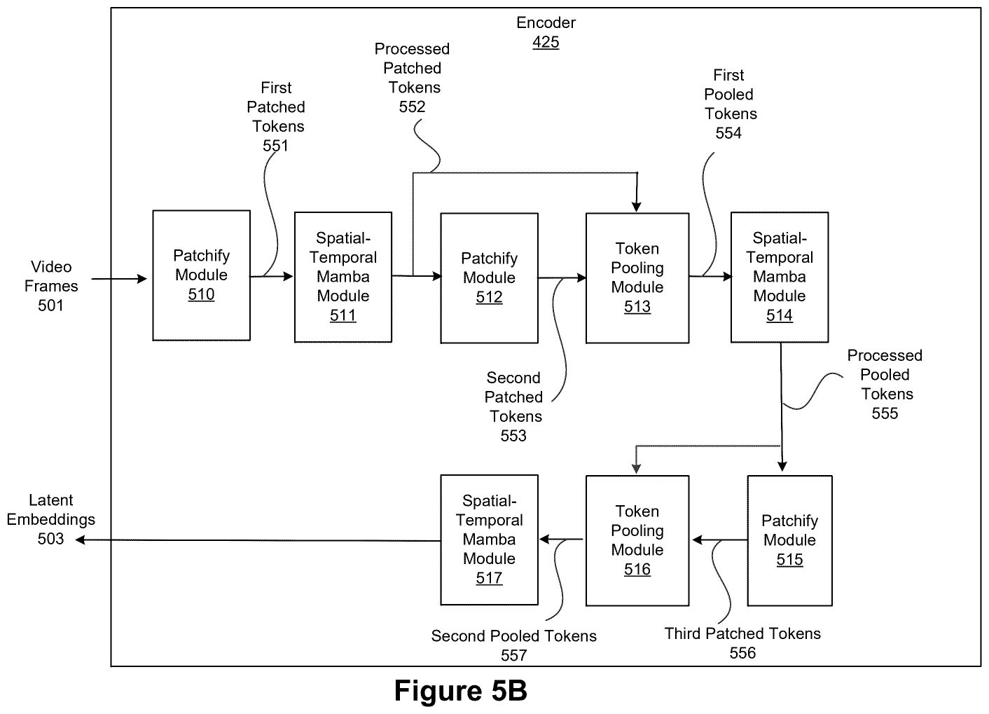

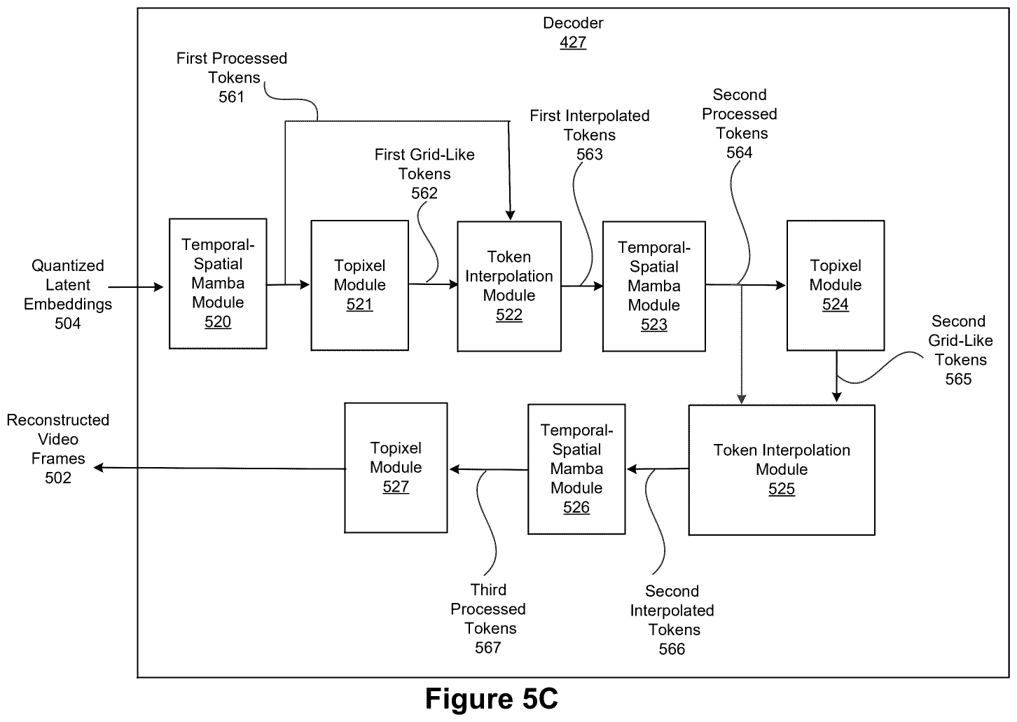

Quantizer 426 processes the latent embeddings and generates one or more quantized latent embeddings. In some embodiments, quantizer 426 includes, without limitation, a channel splitting module, a quantization module, and a concatenation module. The channel-splitting module processes the latent embeddings and generates one or more channel groups. The quantization module processes the channel groups and generates one or more quantized groups. The concatenation module processes the quantized groups and generates the quantized latent embeddings. Decoder 427 is a machine learning model, such as a neural network, which processes the quantized latent embeddings and generates the reconstructed video frames. Decoder 427 includes, without limitation, a first temporal-spatial Mamba module, a first topixel module, a first token interpolation module, a second temporal-spatial Mamba module, a second topixel module, a second token interpolation module, a third temporal-spatial Mamba module, and a third topixel module. The first temporal-spatial Mamba module processes the quantized latent embeddings and generates one or more first processed tokens. The first topixel module processes the first processed tokens and generates one or more first grid-like tokens. The first token interpolation module processes the first grid-like tokens and the first processed tokens and generates one or more first interpolated tokens. The second temporal-spatial Mamba module processes the first interpolated tokens and generates one or more second processed tokens. The second topixel module processes the second processed tokens and generates one or more second grid-like tokens. The second token interpolation module processes the second processed tokens and the second grid-like tokens and generates the second interpolated tokens. The third temporal-spatial Mamba module processes the second interpolated tokens and generates one or more third processed tokens. The third topixel module processes the third processed tokens and generates the reconstructed video frames. Tokenizer model 424 is described in greater detail in conjunction with FIGS. 5A-6 and 9-12.

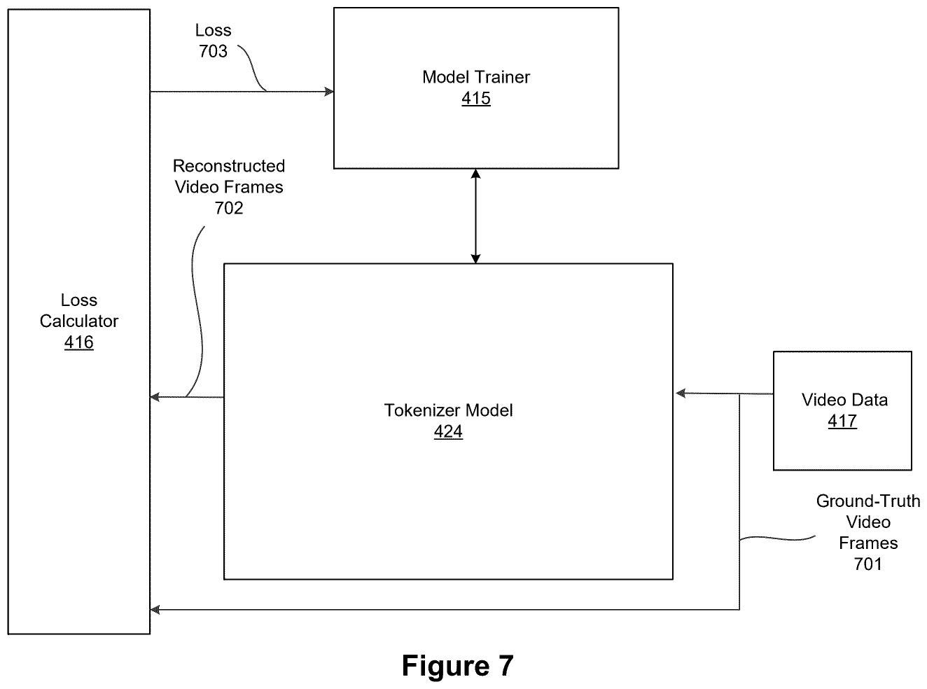

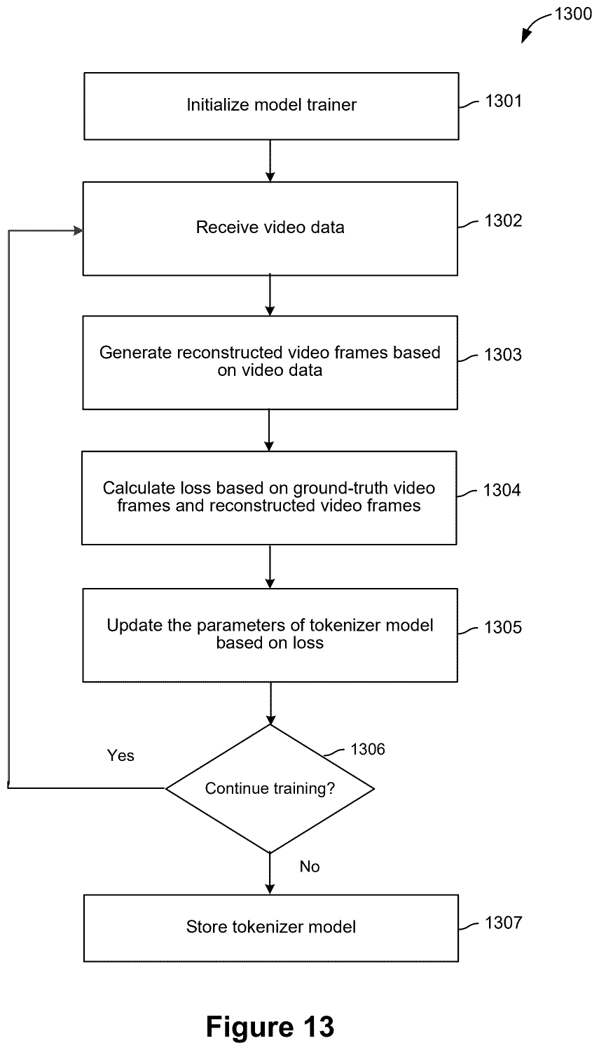

In some embodiments, model trainer 415 trains the tokenizer model based on video data. During training, model trainer 415 uses the loss to iteratively update tokenizer model 424 until one or more stopping criteria are met. In some embodiments, model trainer 415 uses the loss to iteratively update the parameters of tokenizer model 424. Once the training stops, model trainer 415 stores the trained tokenizer model 424 in data store 420 or elsewhere. Model trainer 415 is described in greater detail in conjunction with FIGS. 7 and 13.

In some embodiments, data store 420 includes any storage device or devices, such as fixed disc drive(s), flash drive(s), optical storage, network attached storage (NAS), and/or a storage area-network (SAN). Although shown as accessible over network 430, in at least one embodiment, machine learning server 410 can include data store 420.

Computing device 440 shown herein is for illustrative purposes only, and variations and modifications in the design and arrangement of computing device 440, without departing from the scope of the present disclosure. For example, the number of processors 442, the number of and/or type of memories 444, and/or the number of applications and/or data stored in memory 444 can be modified as desired. In some embodiments, any combination of processor(s) 442 and/or memory 444 can be included in and/or replaced with any type of virtual computing system, distributed computing system, and/or cloud computing environment, such as a public, private, or a hybrid cloud system.

Each of processor(s) 442 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 442 can be any technically feasible hardware unit capable of processing data and/or executing software applications. During operation, processor(s) 442 can receive user input from input devices (not shown), such as a keyboard or a mouse.

Memory 444 of computing device 440 stores content, such as software applications and data, for use by processor(s) 442. As shown, memory 444 includes, without limitation, video generation application 446. Memory 444 can be any type of memory capable of storing data and software applications, such as a RAM, a ROM, an EPROM or a Flash ROM, or any suitable combination of the foregoing. In some embodiments, additional storage (not shown) can supplement or replace memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

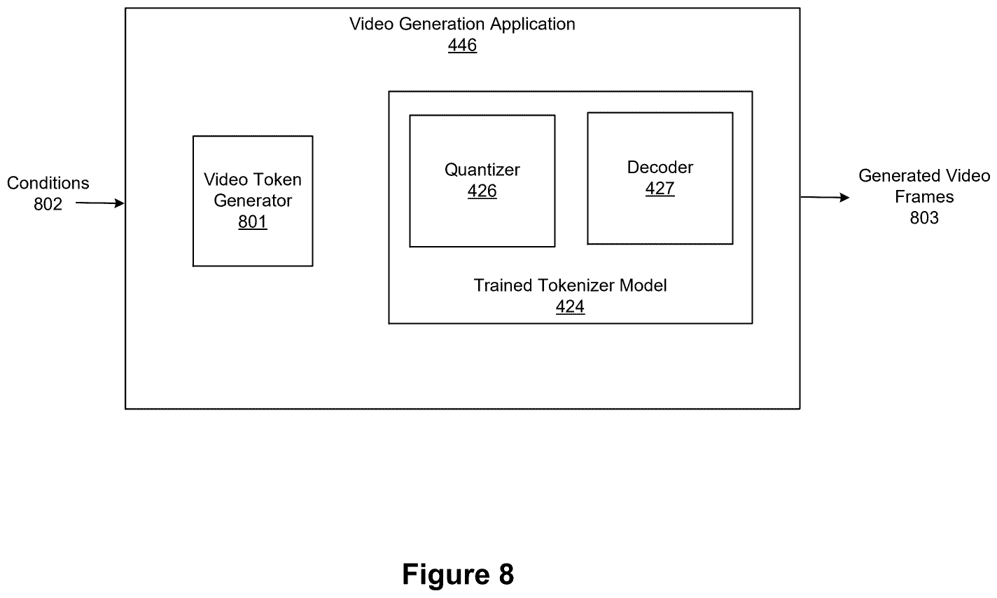

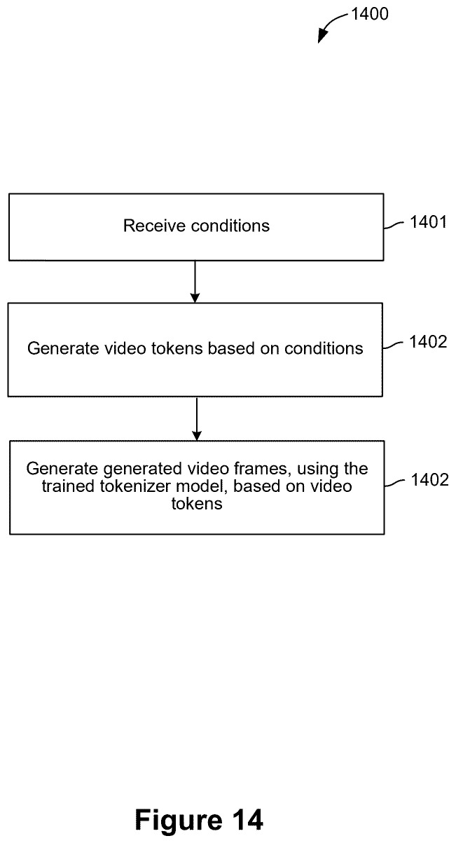

As shown, video generation application 446 is stored in memory 444 and executes on processor(s) 442. Video generation application 446 uses, quantizer 426, and/or decoder 427 included in the trained tokenizer model 424 to process one or more conditions received from one or more I/O devices and generate one or more generated video frames. In some embodiments, video generation application 446 includes a pre-trained video token generator, such as an autoregressive transformer or a diffusion-based sampler, that processes the conditions and generates one or more video tokens (e.g., latent embeddings). Quantizer 426 processes each latent embedding and maps each latent embedding to a corresponding quantized latent embedding in a learned latent space, translating symbolic representations into compressed spatiotemporal features. Decoder 427 then processes the sequence of quantized latent embeddings to reconstruct pixel-level video frames (e.g., reconstructed video frames). Video generation application 446 processes the reconstructed video frames and generates the generated video frames. Video generation application 446 is described in greater detail in conjunction with FIGS. 8 and 14.

FIG. 5A is a more detailed illustration of tokenizer model 424, according to various embodiments. As shown, tokenizer model 424 includes, without limitation, encoder 425, quantizer 426, and decoder 427. In operation, encoder 425 processes video frames 501 and generates latent embeddings 503. Quantizer 426 processes latent embeddings 503 and generates quantized latent embeddings 504. Decoder 427 processes quantized latent embeddings 504 and generates reconstructed video frames 502.

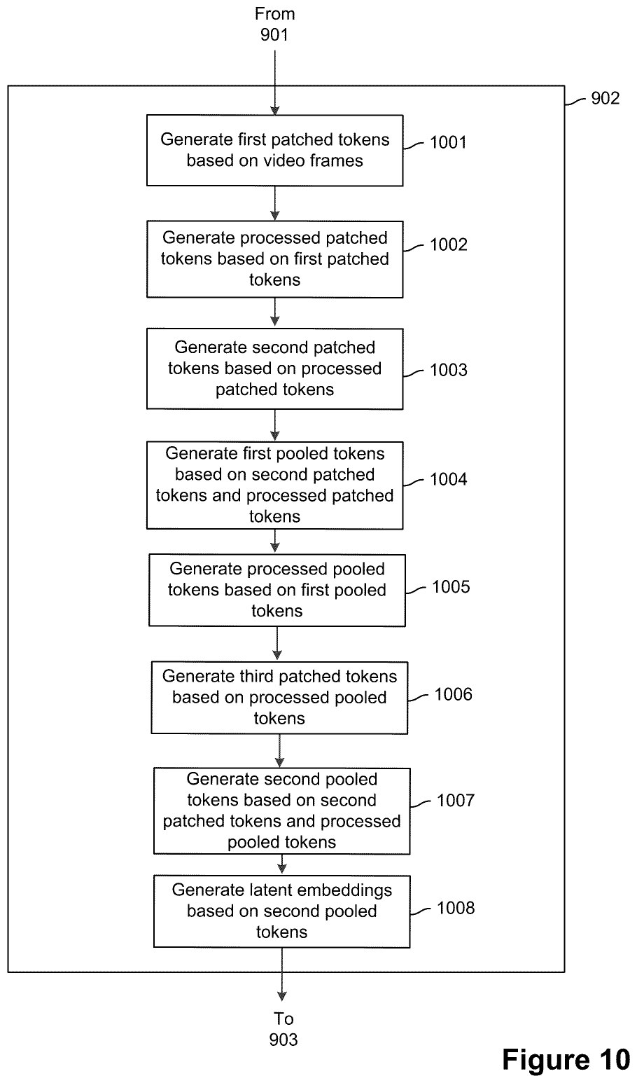

Encoder 425 is a machine learning model, such as a neural network, which processes video frames 501 and generates latent embeddings 503. In some embodiments, encoder 425 includes, without limitation, a first patchify module, a first spatial-temporal Mamba module, a second patchify module, a first token pooling module, a second spatial-temporal Mamba module, a third patchify module, a second token pooling module, and a third spatial-temporal Mamba module. The first patchify module processes video frames 501 and generates one or more first patched tokens. The first spatial-temporal Mamba module processes the first patched tokens and generates one or more processed patched tokens. The second patchify module processes processed patched tokens and generates one or more second patched tokens. The first token pooling module processes the second patched tokens and the processed patched tokens and generates one or more first pooled tokens. The second spatial-temporal Mamba module processes the first pooled tokens and generates one or more processed pooled tokens. The third patchify module processes the processed pooled tokens and generates one or more second patched tokens. The second token pooling module processes the second patched tokens and the processed pooled tokens and generates one or more second pooled tokens. The third spatial-temporal Mamba module processes the second pooled tokens and generates latent embeddings 503. Encoder 425 is described in greater detail in conjunction with FIGS. 5B and 10.

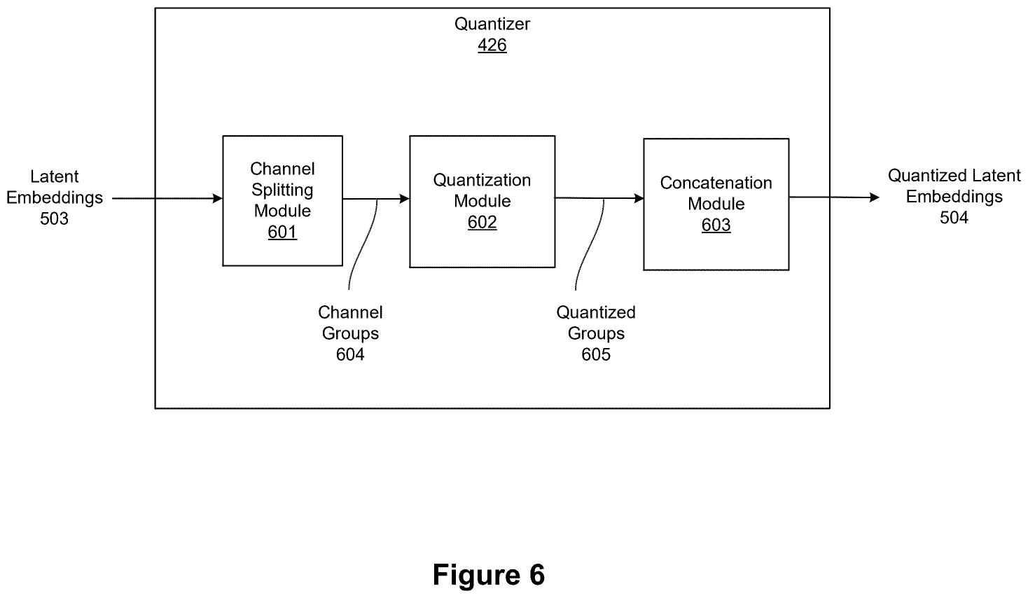

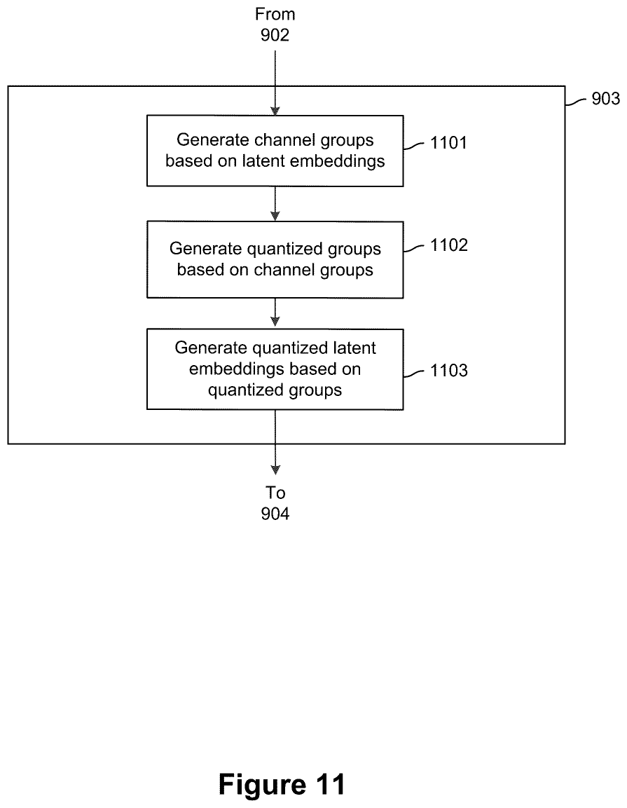

Quantizer 426 processes latent embeddings 503 and generates quantized latent embeddings 504. In some embodiments, quantizer 426 includes, without limitation, a channel splitting module, a quantization module, and a concatenation module. The channel-splitting module processes latent embeddings 503 and generates one or more channel groups. The quantization module processes the channel groups and generates one or more quantized groups. The concatenation module processes the quantized groups and generates quantized latent embeddings 504. Quantizer 426 is described in greater detail in conjunction with FIGS. 6 and 11.

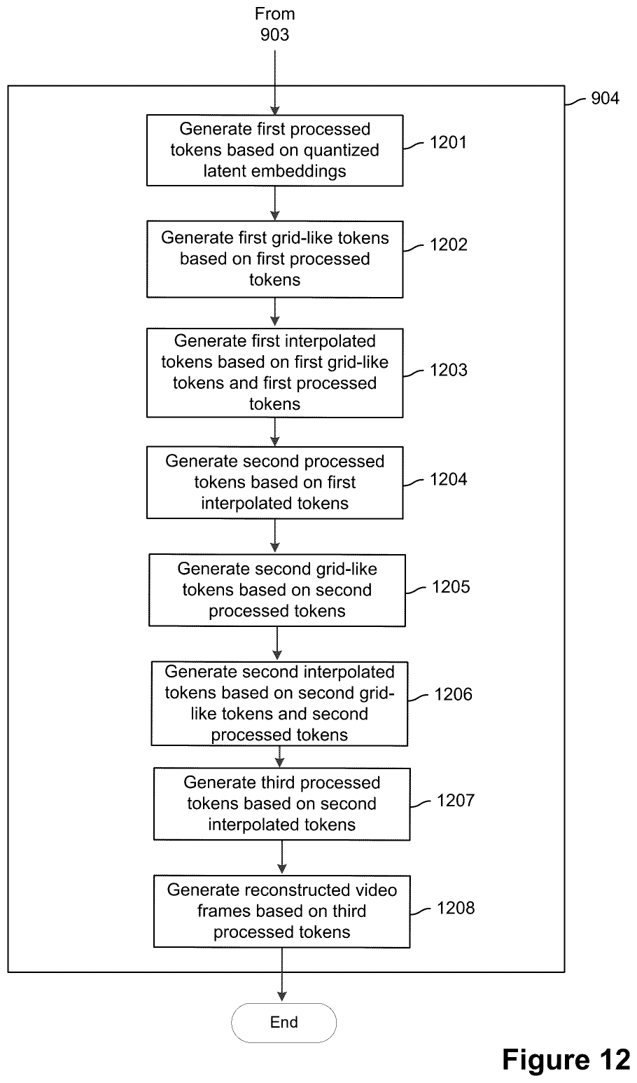

Decoder 427 is a machine learning model, such as a neural network, that processes quantized latent embeddings 504 and generates reconstructed video frames 502. Decoder 427 is a machine learning model, such as a neural network, which processes the quantized latent embeddings and generates the reconstructed video frames. In some embodiments, decoder 427 includes, without limitation, a first temporal-spatial Mamba module, a first topixel module, a first token interpolation module, a second temporal-spatial Mamba module, a second topixel module, a second token interpolation module, a third temporal-spatial Mamba module, and a third topixel module. The first temporal-spatial Mamba module processes quantized latent embeddings 504 and generates one or more first processed tokens. The first topixel module processes the first processed tokens and generates one or more first grid-like tokens. The first token interpolation module processes the first grid-like tokens and the first processed tokens and generates one or more first interpolated tokens. The second temporal-spatial Mamba module processes the first interpolated tokens and generates one or more second processed tokens. The second topixel module processes the second processed tokens and generates one or more second grid-like tokens. The second token interpolation module processes the second processed tokens and the second grid-like tokens and generates the second interpolated tokens. The third temporal-spatial Mamba module processes the second interpolated tokens and generates one or more third processed tokens. The third topixel module processes the third processed tokens and generates reconstructed video frames 501. Decoder 427 is described in greater detail in conjunction with FIGS. 5C and 12.

FIG. 5B a more detailed illustration of encoder 425, according to various embodiments. As shown, encoder 425 includes, without limitation, patchify module 510, spatial-temporal Mamba module 511, patchify module 512, token pooling module 513, spatial-temporal Mamba module 514, patchify module 515, token pooling module 516, and spatial-temporal Mamba module 517. Patchify module 510 processes video frames 501 and generates patched tokens 551. Spatial-temporal Mamba module 511 processes patched tokens 551 and generates processed patched tokens 552. Patchify module 512 processes processed patched tokens 552 and generates patched tokens 553. Token pooling module 513 processes patched tokens 553 and processed patched tokens 552 and generates pooled tokens 554. Spatial-temporal Mamba module 514 processes pooled tokens 554 and generates one or more processed pooled tokens 555. Patchify module 515 processes processed pooled tokens 555 and generates patched tokens 556. Token pooling module 516 processes patched tokens 556 and processed pooled tokens 555 and generates pooled tokens 557. Spatial-temporal Mamba module 517 processes pooled tokens 557 and generates latent embeddings 503.

Patchify module 510 processes video frames 501 and generates patched tokens 551. In some embodiments, patchify module 510 reduces the spatial and temporal dimensions of video frames 501. In some embodiments, patchify module 510 includes a reshape layer that rearranges the input video frames 501 into a sequence of spatiotemporal patches and an embedding layer that computes a feature representation for each patch included in first patched tokens 551. Let L denote the total number of encoder blocks. At each level l∈[1, L], patchify module 510 downsamples the input video frames 501 using a spatiotemporal kernel of size tₗ×hₗ×wₗ, where tₗ, hₗ, and wₗ denote the temporal, height, and width downsampling factors, respectively. The hierarchical patchification is applied recursively across L levels of encoder 425. As a result, first patched tokens 551 has a compacted dimension of T/t×H/h×W/w×c, where

$$t = {\prod }_{l = 1}^{L} {t}_{l} , h = {\prod }_{l = 1}^{L} {h}_{l} , and w = {\prod }_{l = 1}^{L} {w}_{l} ,$$

and c represents the number of channels in the final latent embedding 503. In some embodiments, the embedding layer included in patchify module 510 uses linear or 3D convolutional layers. For example, a 3D convolutional layer included in patchify module 510 can apply a kernel of size 2×4×4 across non-overlapping windows of the video frames 501, such that consecutive frames V_{1:8}, V_{9:16}, . . . , V_{T-7:7} are converted into corresponding spatiotemporal patches included in first patched tokens 551.

Spatial-temporal Mamba module 511 processes first patched tokens 551 and generates processed patched tokens 552. In some embodiments, spatial-temporal Mamba module 511 receives first patched tokens 551 of size b×Tₗ×Hₗ×Wₗ×cₗ, where b is the batch size, Tₗ is the temporal length, Hₗ and Wₗ are the spatial dimensions, and cₗ is the channel dimension at level l of encoder 425. In some embodiments, spatial-temporal Mamba module 511 first applies spatial reasoning by reshaping the token volume into shape (b·Tₗ)×(Hₗ·Wₗ)×cₗ and passing the result to a spatial attention mechanism. The output is then temporally processed by rearranging the tokens into shape (b·Hₗ·Wₗ)×Tₗ×cₗ and applying temporal attention to generate processed patched tokens 552. In some embodiments, spatial-temporal Mamba module 511 includes one or more Mamba layers. Each Mamba layer includes a state space sequence model architecture designed for long-range sequence modeling. Unlike transformers, which rely on explicit positional encodings and quadratic attention operations, Mamba module 511 uses structured state space models (SSMs) in a recurrent formulation that naturally captures temporal dependencies with linear complexity. In some embodiments, the spatial-temporal Mamba module 511 uses either Mamba-1 or Mamba-2 architectures. In some examples, spatial-temporal Mamba module 511 includes two stacked spatial Mamba layers followed by two temporal Mamba layers.

Patchify module 512 processes processed patched tokens 552 and generates second patched tokens 553. In some embodiments, patchify module 510 reduces the spatial and temporal dimensions of patched tokens 552. In some embodiments, patchify module 512 includes a reshape layer that rearranges the input patched tokens 552 into a sequence of spatiotemporal patches and an embedding layer that computes a feature representation for each patch included in second patched tokens 553. At each level l∈[1, L], patchify module 512 downsamples the input processed patched tokens 552 using a spatiotemporal kernel of size tₗ×hₗ×wₗ. The hierarchical patchification is applied recursively across L levels of encoder 425. As a result, second patched tokens 553 has a compacted dimension of T/t×H/h×W/w×c. In some embodiments, the embedding layer included in patchify module 512 uses linear or 3D convolutional layers. For example, a 3D convolutional layer included in patchify module 512 can apply a kernel of size 2×2×2 across non-overlapping windows of processed patched tokens 552.

Token pooling module 513 processes processed patched tokens 552 and second patched tokens 553 and generates first pooled tokens 554. In some embodiments, token pooling module 513 facilitates hierarchical encoding in the encoder 425 by introducing skip connections between encoder blocks. Let vₗ denote the encoded tokens at encoder level l, such as processed patched tokens 552. To combine information across levels, the output tokens, such as first pooled tokens 554, vₗ₋₁ from the previous level are downsampled using 3D average pooling with a kernel size of tₗ×hₗ×wₗ, where tₗ, hₗ, and wₗ represent the temporal and spatial kernel sizes at level. The downsampled tokens are then added to the corresponding tokens vₗ, such as second patched tokens 553, to form a residual connection that results in first pooled tokens 554. The residual skip connections help preserve higher-level semantic information across levels and support coarse-to-fine representation learning for video encoding.

Spatial-temporal Mamba module 514 processes first pooled tokens 554 and generates processed pooled tokens 555. In some embodiments, spatial-temporal Mamba module 514 receives first pooled tokens 554 of size b×Tₗ×Hₗ×Wₗ×cₗ. In some embodiments, spatial-temporal Mamba module 514 first applies spatial reasoning by reshaping the token volume into shape (b·Tₗ)×(Hₗ·Wₗ)×cₗ and passing the result to a spatial attention mechanism. The output is then temporally processed by rearranging the tokens into shape (b·Hₗ·Wₗ)×Tₗ×cₗ and applying temporal attention to generate processed pooled tokens 555. In some embodiments, spatial-temporal Mamba module 514 includes one or more Mamba layers. In some embodiments, the spatial-temporal Mamba module 514 uses either Mamba-1 or Mamba-2 architectures. In some examples, spatial-temporal Mamba module 514 includes three stacked spatial Mamba layers followed by three temporal Mamba layers.

Patchify module 515 processes processed pooled tokens 555 and generates third patched tokens 556. In some embodiments, patchify module 515 reduces the spatial and temporal dimensions of processed pooled tokens 555. In some embodiments, patchify module 515 includes a reshape layer that rearranges the input processed pooled tokens 555 into a sequence of spatiotemporal patches and an embedding layer that computes a feature representation for each patch included in third patched tokens 556. At each level l∈[1, L], patchify module 515 downsamples the input processed pooled tokens 555 using a spatiotemporal kernel of size tₗ×hₗ×wₗ. The hierarchical patchification is applied recursively across L levels of encoder 425. As a result, third patched tokens 556 has a compacted dimension of T/t×H/h×W/w×c. In some embodiments, the embedding layer included in patchify module 515 uses linear or 3D convolutional layers. For example, a 3D convolutional layer included in patchify module 515 can apply a kernel of size 2×1×1 across non-overlapping windows of processed pooled tokens 555.

Token pooling module 516 processes processed pooled tokens 555 and third patched tokens 556 and generates second pooled tokens 557. In some embodiments, token pooling module 516 facilitates hierarchical encoding in the encoder 425 by introducing skip connections between encoder blocks. Let vₗ denote the encoded tokens at encoder level l, such as second pooled tokens 555. To combine information across levels, the output tokens, such as first pooled tokens 554, v₁₋₁ from the previous level are downsampled using 3D average pooling with a kernel size of tₗ×hₗ×wₗ, where tₗ, hₗ, and wₗ represent the temporal and spatial kernel sizes at level l. The downsampled tokens are then added to the corresponding tokens vₗ, such as third patched tokens 556, to form a residual connection that results in second pooled tokens 557. The residual skip connections help preserve higher-level semantic information across levels and support coarse-to-fine representation learning for video encoding.

Spatial-temporal Mamba module 517 processes second pooled tokens 557 and generates latent embeddings 503. In some embodiments, spatial-temporal Mamba module 517 receives second pooled tokens 557 of size b×Tₗ×Hₗ×Wₗ×cₗ. In some embodiments, spatial-temporal Mamba module 517 first applies spatial reasoning by reshaping the token volume into shape (b·Tₗ)×(Hₗ·Wₗ)×cₗ and passing the result to a spatial attention mechanism. The output is then temporally processed by rearranging the tokens into shape (b·Hₗ·Wₗ)×Tₗ×cₗ and applying temporal attention to generate latent embedding 503. In some embodiments, spatial-temporal Mamba module 517 includes one or more Mamba layers. In some embodiments, the spatial-temporal Mamba module 517 uses either Mamba-1 or Mamba-2 architectures. In some examples, spatial-temporal Mamba module 517 includes four stacked spatial Mamba layers followed by four temporal Mamba layers.

FIG. 5C is a more detailed illustration of decoder 427, according to various embodiments. Decoder 427 is a machine learning model, such as a neural network, which processes quantized latent embeddings 504 and generates reconstructed video frames 502. In some embodiments, decoder 427 includes, without limitation, temporal-spatial Mamba module 520, topixel module 521, token interpolation module 522, temporal-spatial Mamba module 523, topixel module 524, token interpolation module 525, temporal-spatial Mamba module 526, and topixel module 527. Temporal-spatial Mamba module 520 processes quantized latent embeddings 504 and generates first processed tokens 561. Topixel module 521 processes first processed tokens 561 and generates first grid-like tokens 562. Token interpolation module 522 processes first grid-like tokens 562 and first processed tokens 561 and generates first interpolated tokens 563. Temporal-spatial Mamba module 523 processes first interpolated tokens 563 and generates second processed tokens 564. Topixel module 524 processes second processed tokens 564 and generates second grid-like tokens 565. Token interpolation module 525 processes second processed tokens 564 and second grid-like tokens 565 and generates second interpolated tokens 566. Temporal-spatial Mamba module 526 processes second interpolated tokens 566 and generates third processed tokens 567. Topixel module 527 processes third processed tokens 567 and generates reconstructed video frames 502.

Temporal-spatial Mamba module 520 processes quantized latent embeddings 504 and generates first processed tokens 561. In some embodiments, input quantized latent embeddings 504 include quantized latent embeddings with shape [symbol] ∈ [symbol] where b is the batch size, T is the number of frames, H×W is the spatial resolution of each frame, and c is the number of channels. Temporal-spatial Mamba module 520 first applies temporal Mamba layers by reshaping the input to [symbol] ∈ [symbol] and applying recurrent-style linear attention across the time dimension to model motion dynamics. The output is then reshaped to [symbol] ∈ [symbol] and spatial Mamba layers are applied to capture per-frame spatial relationships generating first processed token 561 with the shape [symbol] . In some example, temporal-spatial Mamba module 520 include four temporal Mamba layers followed by four spatial Mamba layers.

Topixel module 521 processes first processed tokens 561 and generates first grid-like tokens 562. In some embodiments, topixel module 521 increases the spatial and temporal dimensions of a given token volume, such as first processed tokens 561. In some embodiments, topixel module 521 includes an embedding layer that uses 3D convolution to project the channel dimension of each token included in first processed tokens 561 to a desired size, followed by a pixelshuffle layer that rearranges the projected tokens into an upsampled spatio-temporal grid included in first grid-like tokens 562. For example, given token input, such as first processed tokens 561, of shape [symbol] ∈ [symbol] the embedding layer projects the token input to a higher channel dimension, and the pixelshuffle operation rearranges the data to [symbol] where t₁×hₗ×wₗ denotes the spatio-temporal upsampling factor at decoder level l mirroring the downsampling kernel used in the corresponding patchify module included in encoder 425. In some examples, topixel module 521 includes an upsampling kernel of 2×1×1 which uses a pixelshuffle operation to double the temporal resolution of the tokens while keeping the spatial resolution unchanged.

Token interpolation module 522 processes first processed tokens 561 and first grid-like tokens 562 and generates first interpolated tokens 563. In some embodiments, token interpolation module 522 implements skip connections between different decoder blocks to improve the reconstruction quality of the decoded video. Given decoded tokens \hat{v}ₗ₊₁ from a deeper decoder block, such as first grid-like tokens 562, and skip-connected tokens \hat{v}ₗ from an earlier encoder layer, such as first processed tokens 561, token interpolation module 522 upsamples \hat{v}ₗ₊₁ using nearest-neighbor interpolation in the temporal and spatial dimensions to match the resolution of \hat{v}ₗ, to generate upsampled tokens

$${\hat{v}}_{l + 1}^{↑} .$$

The unsampled tokens

$${\hat{v}}_{l + 1}^{↑}$$

are then added elementwise to \hat{v}ₗ, such as first processed tokens 561, to obtain the interpolated tokens, such as first interpolated tokens 561,

$${\hat{v}}_{l}^{interp} = {\hat{v}}_{l} + {\hat{v}}_{l + 1}^{↑} .$$

Temporal-spatial Mamba module 523 is an application that processes first interpolated tokens 563 and generates second processed tokens 564. In some embodiments, input first interpolated tokens 563 include tokens with shape [symbol] ∈ [symbol] where b is the batch size, T is the number of frames, H×W is the spatial resolution of each frame, and c is the number of channels. Temporal-spatial Mamba module 523 first applies temporal Mamba layers by reshaping the input to [symbol] ∈ [symbol] and applying recurrent-style linear attention across the time dimension to model motion dynamics. The output is then reshaped to [symbol] ∈ [symbol] and spatial Mamba layers are applied to capture per-frame spatial relationships generating second processed token 564 with the shape [symbol] . In some example, temporal-spatial Mamba module 520 include three temporal Mamba layers followed by three spatial Mamba layers.

Topixel module 524 processes second processed tokens 564 and generates second grid-like tokens 565. In some embodiments, topixel module 524 increases the spatial and temporal dimensions of a given token volume, such as second processed tokens 564. In some embodiments, topixel module 524 includes an embedding layer that uses 3D convolution to project the channel dimension of each token included in second processed tokens 564 to a desired size, followed by a pixelshuffle layer that rearranges the projected tokens into an upsampled spatio-temporal grid included in second grid-like tokens 565. In some examples, topixel module 521 includes an upsampling kernel of 2×2×2 which uses a pixelshuffle operation to double both the temporal and spatial resolution of second processed tokens 564.

Token interpolation module 525 processes second processed tokens 564 and second grid-like tokens 565 and generates second interpolated tokens 566. In some embodiments, token interpolation module 525 implements skip connections between different decoder blocks to improve the reconstruction quality of the decoded video. Given decoded tokens \hat{v}ₗ₊₁ from a deeper decoder block, such as second processed tokens 564, and skip-connected tokens, from an earlier encoder layer, such as second processed tokens 564, token interpolation module 525 upsamples \hat{v}ₗ₊₁ using nearest-neighbor interpolation in the temporal and spatial dimensions to match the resolution of \hat{v}ₗ, to generate upsampled tokens

$${\hat{v}}_{l + 1}^{↑} .$$

The unsampled tokens

$${\hat{v}}_{l + 1}^{↑}$$

are then added elementwise to \hat{v}ₗ, such as second processed tokens 564, to obtain the interpolated tokens, such as second interpolated tokens 566,

$${\hat{v}}_{l}^{interp} = {\hat{v}}_{l} + {\hat{v}}_{l + 1}^{↑} .$$

Temporal-spatial Mamba module 526 processes second interpolated tokens 566 and generates third processed tokens 567. In some embodiments, input second interpolated tokens 566 include tokens with shape [symbol] ∈ [symbol] where b is the batch size, T is the number of frames, H×W is the spatial resolution of each frame, and c is the number of channels. Temporal-spatial Mamba module 526 first applies temporal Mamba layers by reshaping the input to [symbol] ∈ [symbol] and applying recurrent-style linear attention across the time dimension to model motion dynamics. The output is then reshaped to [symbol] ∈ [symbol] and spatial Mamba layers are applied to capture per-frame spatial relationships generating third processed token 567 with the shape [symbol] . In some example, temporal-spatial Mamba module 526 include two temporal Mamba layers followed by two spatial Mamba layers.

Topixel module 527 processes third processed tokens 567 and generates reconstructed video frames 502. In some embodiments, topixel module 527 increases the spatial and temporal dimensions of a given token volume, such as third processed tokens 567. In some embodiments, topixel module 527 includes an embedding layer that uses 3D convolution to project the channel dimension of each token included in third processed tokens 567 to a desired size, followed by a pixelshuffle layer that rearranges the projected tokens into an upsampled spatio-temporal grid included in third grid-like tokens 567. In some examples, topixel module 527 includes an upsampling kernel of 2×4×4 which uses a pixelshuffle operation to to double the temporal resolution and quadruple the spatial resolution of third processed tokens 567.

### Channel-Split Quantization

FIG. 6 a more detailed illustration of quantizer 426, according to various embodiments. As shown, quantizer 436 includes, without limitation, channel splitting module 601, quantization module 602, and concatenation module 603. In operation, channel splitting module 601 processes latent embeddings 503 and generates channel groups 604. Quantization module 602 processes channel groups 604 and generates quantized groups 605. Concatenation module 603 processes quantized groups 605 and generates quantized latent embeddings 504.

Channel splitting module 601 processes latent embeddings 503 and generates channel groups 604. In some embodiments, channel splitting module 601 first increases the channel size of each latent embedding 503 by a factor of K, such that the updated channel dimension becomes c·K, where c is the original number of channels in the latent embedding 503 and K is a predefined channel expansion factor. Let the input video frames 501 be denoted as V∈ [symbol] , and let latent embedding 503 be v∈ [symbol] , where t, h, w are the temporal and spatial downsampling strides, and c is the latent channel size. In some embodiments, channel splitting module 601 first increases the channel dimension c to c. K, then divided into K groups: v={v₁, v₂, . . . , v_{K}}, where each group vₖ ∈ [symbol] . In some examples, the channel expansion is performed using a 1×1×1 convolutional layer that maps the latent embedding 503 to a higher-dimensional space. Each channel group vₖ can be subsequently routed to a separate quantization stream, enabling independent processing by downstream quantizers included in quantization module 602. In some embodiments, channel splitting module 601 omits the initial channel expansion and instead partition the original latent embedding v∈ [symbol] directly into K groups of equal or variable channel width to reduce computational overhead, which is beneficial in lightweight or low-latency deployment scenarios. In some embodiments, channel splitting module 601 includes channel-wise attention or learned gating mechanisms to dynamically determine how the input channels included in latent embedding 503 are grouped.

Quantization module 602 processes channel groups 604 and generates quantized groups 605. In some embodiments, quantization module 602 quantizes each group vₖ∈ [symbol] included in channel groups 604 independently. In some embodiments, quantization module 602 applies Channel-Split Look-Up-Free Quantization (CSLFQ) to each group. Let the codebook size be |C|=2^{N}, then CS-LFQ sets cₖ=N, and each value in vₖ is binarized to −1 or +1 using, for example,

$$\hat{v} = sign ( v ) \qquad ( Equation 1 )$$

where the sign function outputs −1 for values≤0 and +1 otherwise. The quantized output \hat{v} included in quantized groups 605 is then used as the discrete token. Since the values are binary, CS-LFQ is computationally efficient but has limited representational power compared to vector quantization (VQ). In some embodiments, quantization module 602 uses Channel-Split Finite-Scalar Quantization (CS-FSQ). In CS-FSQ, each group vₖ is first passed through a nonlinear activation function ƒ, such as:

$$\hat{v} = round ( f ( v ) ) , where f ( v ) = ⌊ \frac{L}{2} tanh ( v ) ⌋ , \qquad ( Equation 2 )$$

and then rounded to the nearest integer from a discrete set of L unique scalar levels. For a codebook size

$$\vert C \vert = {\prod }_{i = 1}^{M} {L}_{i} = {2}^{N} ,$$

the required channel size for CS-FSQ is c_{fsq}=M<<N. For example, when |C|=2¹⁶, the channel size c_{lfq}=16, while c_{fsq}=6. In some embodiments, quantization module 602 applies a hybrid or learned selection strategy, dynamically choosing LFQ or FSQ per group included in channel groups 604 based on reconstruction error, entropy regularization, or visual fidelity requirements.

Concatenation module 603 is an application that processes quantized groups 605 and generates quantized latent embeddings 504. In some embodiments, concatenation module 603 concatenates quantized groups 605 \hat{v}₁, . . . , \hat{v}ₖ along the channel dimension to generate the complete quantized latent embeddings 504 \hat{v}, for example, as described by

$$\hat{v} = concat ( {\hat{v}}_{1} , … , {\hat{v}}_{K} ) \qquad ( Equation 3 )$$

In some embodiments, to preserve the total number of quantized latent embeddings 504 when the channel size is increased by a factor of K, the spatio-temporal compression rate of encoder 425 is increased proportionally by K. Specifically, for input video frames 501 V with shape T×H×W×3, and spatio-temporal downsampling of t×h×w, the number of quantized latent embeddings 504 is

$$\frac{THW}{thw} .$$

After increasing the channel size by K, the sequence length remains constant by adjusting the compression rate to thw·K, leading to the number of quantized latent embeddings 504 being

$$\frac{HWT}{thw \cdot K} .$$

### Training the Mamba-Based Tokenizer Model

FIG. 7 is a more detailed illustration of model trainer 415, according to various embodiments. In operation, tokenizer model 424 processes video data 417 and generates reconstructed video frames 702. Loss calculator 416 calculates loss 703 based on ground-truth video frames 701 included in video data 417 and reconstructed video frames 702. Model trainer 415 uses loss 703 to iteratively update the parameters of tokenizer model 424 until one or more stopping criteria are met.

Tokenizer model 424 is a machine learning model that processes ground-truth video frames 701 included in video data 417 and generates reconstructed video frames 702. In some embodiments, tokenizer model 424 includes, without limitation, encoder 425, quantizer 426, and decoder 427. In operation, encoder 425 processes ground-truth video frames 701 included in video data 417 and generates latent embeddings 503. Quantizer 426 processes latent embeddings 503 and generates quantized latent embeddings 504. Decoder 427 processes quantized latent embeddings 504 and generates reconstructed video frames 702.

Loss calculator 416 is an application that calculates loss 703 based on one or more reconstructed video frames 702 and one or more ground-truth video frames 701 included in video data 417. In some embodiments, loss calculator 416 uses a combination of loss functions, including but not limited to (i) a reconstruction loss that minimizes the L₁ (Manhattan distance) between corresponding pixels of the ground-truth video frames and the reconstructed video frames, (ii) a perceptual loss that computes frame-wise perceptual similarity using the LPIPS metric between the ground-truth video frames and the reconstructed video frames, and/or (iii) a GAN loss that uses a 3D convolutional PatchGAN discriminator to differentiate real videos from generated reconstructed video frames. In some embodiments, for certain tokenization strategies included in quantizer 426, such as LFQ, loss calculator 416 includes entropy penalties and commitment losses. In some embodiments, whenever quantizer 426 includes FSQ, loss calculator 416 bypasses explicit codebook loss computation.

Model trainer 415 uses loss 703 to iteratively update the parameters of tokenizer model 424. In some embodiments, model trainer 415 uses various optimization algorithms, such as adaptive moment estimation (Adam), weighted Adam (AdamW) with a cosine annealing learning rate schedule, and/or the like. In some embodiments, model trainer 415 begins the training with a linear warm-up phase over a fixed number of steps (e.g., 10,000 steps) to stabilize early learning dynamics. In some examples, model trainer 415 uses an initial learning rate in the range of 2×10⁻⁴ to 5×10⁻⁴, depending on the architecture of tokenizer model 424 and dataset size of video data 417. In some embodiments, model trainer 415 uses gradient clipping to maintain numerical stability and prevent exploding gradients, especially when training with deep recurrent attention modules, such as Mamba. In some examples, model trainer 415 uses mixed-precision training using automatic mixed precision (AMP) to improve training throughput and reduce GPU memory consumption. In some embodiments, model trainer 415 uses one or more checkpointing and early stopping criteria based on a validation set included in video data 417. In some embodiments, model trainer 415 stops training after a fixed number of steps (e.g., 500,000) or when the validation reconstruction quality does not improve for a predefined number of evaluation intervals (e.g., no improvement in 10 consecutive checkpoints). Additional stopping criteria include convergence of codebook usage statistics or token entropy reaching a stable threshold. In some embodiments, model trainer 415 maintains exponential moving averages (EMA) of the parameters of tokenizer model 415 to stabilize training and improve final evaluation performance. In some embodiments, model trainer 415 stores the trained tokenizer model 424 in data store 420 or elsewhere.

FIG. 8 is a more detailed illustration of video generation application 446, according to various embodiments. As shown, video generation application 446 includes, without limitation, video token generator 801 and trained tokenizer model 424. Trained tokenizer model 424 includes, without limitation, quantizer 426 and decoder 427. In operation, video generation application 446 uses video token generator 801 to process conditions 802 and generates one or more latent embeddings 503. Quantizer 426 processes latent embeddings 503 and generates quantized latent embeddings 504. Decoder 427 processes quantized latent embeddings 504 and generates reconstructed video frames 502. Video generation application 446 processes reconstructed video frames 502 and generates generated video frames 803.

Video generation application 446 uses quantizer 426 and decoder 427 included in the trained tokenizer model 424 to process one or more conditions 802 received from one or more I/O devices and generate one or more generated video frames 803. In some embodiments, video generation application 336 includes a pre-trained video token generator, such as an autoregressive transformer or a diffusion-based sampler, that processes conditions 802 and generates one or more latent embeddings 503. Quantizer 426 processes each latent embedding 503 and maps each latent embedding 503 to a corresponding quantized latent embedding 504 in a learned latent space, translating symbolic representations into compressed spatiotemporal features. Decoder 427 then processes the sequence of quantized latent embeddings 504 to generate reconstructed video frames 502. Video generation application 446 processes reconstructed video frames 502 and generates generated video frames 803. In some embodiments, video generation application 446 applies one or more post-processing operations such as temporal smoothing, frame alignment, or resolution adjustment, and composes reconstructed video frames 502 into a continuous video stream included in generated video frames 803.

### Video Generation Using the Trained Mamba-Based Tokenizer Model

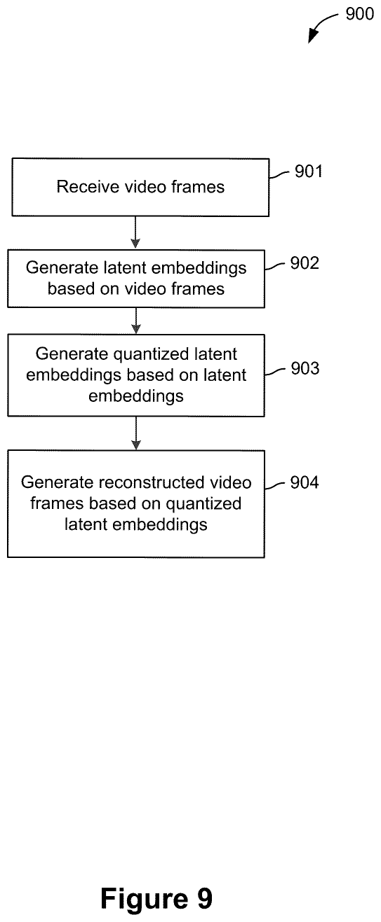

FIG. 9 is a flow diagram of method steps for generating reconstructed video frames 502, according to various embodiments. Although the method steps are described in conjunction with the systems of FIGS. 1-8, persons skilled in the art will understand that any system configured to perform the method steps in any order falls within the scope of the present disclosure.

As shown, a method 900 begins at step 901 where encoder 425 receives video frames 501. In some embodiments, video frames 501 are received from at least one of one or more I/O devices or video data 417.

At step 902, encoder 425 generates latent embeddings 503 based on video frames 501. In some embodiments, encoder 425 includes, without limitation, patchify module 510, spatial-temporal Mamba module 511, patchify module 512, token pooling module 513, spatial-temporal Mamba module 514, patchify module 515, token pooling module 516, and spatial-temporal Mamba module 517. Patchify module 510 processes video frames 501 and generates patched tokens 551. Spatial-temporal Mamba module 511 processes patched tokens 551 and generates processed patched tokens 552. Patchify module 512 processes processed patched tokens 552 and generates patched tokens 553. Token pooling module 513 processes patched tokens 553 and processed patched tokens 552 and generates pooled tokens 554. Spatial-temporal Mamba module 514 processes pooled tokens 554 and generates one or more processed pooled tokens 555. Patchify module 515 processes processed pooled tokens 555 and generates patched tokens 556. Token pooling module 516 processes patched tokens 556 and processed pooled tokens 555 and generates pooled tokens 557. Spatial-temporal Mamba module 517 processes pooled tokens 557 and generates latent embeddings 503. Step 902 is described in greater detail in conjunction with FIG. 10.

At step 903, quantizer 426 generates quantized latent embeddings 504 based on latent embeddings 503. In some embodiments, quantizer 426 includes, without limitation, channel splitting module 601, quantization module 602, and concatenation module 603. In operation, channel splitting module 601 processes latent embeddings 503 and generates channel groups 604. Quantization module 602 processes channel groups 604 and generates quantized groups 605. Concatenation module 603 processes quantized groups 605 and generates quantized latent embeddings 504. Step 903 is described in greater detail in conjunction with FIG. 11.

At step 904, decoder 427 generates reconstructed video frames 502 based on quantized latent embeddings 504. In some embodiments, decoder 427 includes, without limitation, temporal-spatial Mamba module 520, topixel module 521, token interpolation module 522, temporal-spatial Mamba module 523, topixel module 524, token interpolation module 525, temporal-spatial Mamba module 526, and topixel module 527. Temporal-spatial Mamba module 520 processes quantized latent embeddings 504 and generates first processed tokens 561. Topixel module 521 processes first processed tokens 561 and generates first grid-like tokens 562. Token interpolation module 522 processes first grid-like tokens 562 and first processed tokens 561 and generates first interpolated tokens 563. Temporal-spatial Mamba module 523 processes first interpolated tokens 563 and generates second processed tokens 564. Topixel module 524 processes second processed tokens 564 and generates second grid-like tokens 565. Token interpolation module 525 processes second processed tokens 564 and second grid-like tokens 565 and generates second interpolated tokens 566. Temporal-spatial Mamba module 526 processes second interpolated tokens 566 and generates third processed tokens 567. Topixel module 527 processes third processed tokens 567 and generates reconstructed video frames 502. Step 904 is described in greater detail in conjunction with FIG. 12.

FIG. 10 is a flow diagram of method steps for generating latent embeddings 503 based on video frames 501, according to various embodiments. Although the method steps are described in conjunction with the systems of FIGS. 1-8, persons skilled in the art will understand that any system configured to perform the method steps in any order falls within the scope of the present disclosure.

As shown, step 902 begins at step 1001, where patchify module 510 generates first patched tokens 551 based on video frames 501. In some embodiments, patchify module 510 reduces the spatial and temporal dimensions of video frames 501. In some embodiments, patchify module 510 includes a reshape layer that rearranges the input video frames 501 into a sequence of spatiotemporal patches and an embedding layer that computes a feature representation for each patch included in first patched tokens 551. Let L denote the total number of encoder blocks. At each level l E [1, L], patchify module 510 downsamples the input video frames 501 using a spatiotemporal kernel of size tₗ×hₗ×wₗ. The hierarchical patchification is applied recursively across L levels of encoder 425. As a result, first patched tokens 551 has a compacted dimension of T/t×H/h×W/w×c, where

$$t = {\prod }_{l = 1}^{L} {t}_{l} , h = {\prod }_{l = 1}^{L} {h}_{l} , and$$

$$w = {\prod }_{l = 1}^{L} {w}_{l} ,$$

and c represents the number of channels in the final latent embedding 503. In some embodiments, the embedding layer included in patchify module 510 uses linear or 3D convolutional layers. For example, a 3D convolutional layer included in patchify module 510 can apply a kernel of size 2×4×4 across non-overlapping windows of the video frames 501, such that consecutive frames V_{1:8}, V_{9:16}, . . . , V_{T-7:T} are converted into corresponding spatiotemporal patches included in first patched tokens 551.

At step 1002, spatial-temporal Mamba module 511 generates processed patched tokens 552 based on first patched tokens 551. In some embodiments, spatial-temporal Mamba module 511 receives first patched tokens 551 of size b×Tₗ×Hₗ×Wₗ×cₗ. In some embodiments, spatial-temporal Mamba module 511 first applies spatial reasoning by reshaping the token volume into shape (b·Tₗ)×(Hₗ·Wₗ)×cₗ and passing the result to a spatial attention mechanism. The output is then temporally processed by rearranging the tokens into shape (b·Hₗ·Wₗ)×Tₗ×cₗ and applying temporal attention to generate processed patched tokens 552. In some embodiments, spatial-temporal Mamba module 511 includes one or more Mamba layers. In some embodiments, the spatial-temporal Mamba module 511 uses either Mamba-1 or Mamba-2 architectures. In some examples, spatial-temporal Mamba module 511 includes two stacked spatial Mamba layers followed by two temporal Mamba layers.

At step 1003, patchify module 512 generates second patched tokens 553 based on processed patched tokens 552. In some embodiments, patchify module 510 reduces the spatial and temporal dimensions of patched tokens 552. In some embodiments, patchify module 512 includes a reshape layer that rearranges the input patched tokens 552 into a sequence of spatiotemporal patches and an embedding layer that computes a feature representation for each patch included in second patched tokens 553. At each level l∈[1, L], patchify module 512 downsamples the input processed patched tokens 552 using a spatiotemporal kernel of size tₗ×hₗ×wₗ. The hierarchical patchification is applied recursively across L levels of encoder 425. As a result, second patched tokens 553 has a compacted dimension of T/t×H/h×W/w×c. In some embodiments, the embedding layer included in patchify module 512 uses linear or 3D convolutional layers. For example, a 3D convolutional layer included in patchify module 512 can apply a kernel of size 2×2×2 across non-overlapping windows of processed patched tokens 552.

At step 1004, token pooling module 513 generates first pooled tokens 554 based on second patched tokens 553 and processed patched tokens 552. In some embodiments, token pooling module 513 facilitates hierarchical encoding in the encoder 425 by introducing skip connections between encoder blocks. Let vₗ denote the encoded tokens at encoder level l, such as processed patched tokens 552. To combine information across levels, the output tokens, such as first pooled tokens 554, vₗ₋₁ from the previous level are downsampled using 3D average pooling with a kernel size of tₗ×hₗ×wₗ, where tₗ, hₗ, and wₗ represent the temporal and spatial kernel sizes at level l. The downsampled tokens are then added to the corresponding tokens vₗ, such as second patched tokens 553, to form a residual connection that results in first pooled tokens 554.

At step 1005, spatial-temporal Mamba module 514 generates processed pooled tokens 555 based on first pooled tokens 554. In some embodiments, spatial-temporal Mamba module 514 receives first pooled tokens 554 of size b×Tₗ×Hₗ×Wₗ×cₗ. In some embodiments, spatial-temporal Mamba module 514 first applies spatial reasoning by reshaping the token volume into shape (b·Tₗ)×(Hₗ·Wₗ)×cₗ and passing the result to a spatial attention mechanism. The output is then temporally processed by rearranging the tokens into shape (b·Hₗ·Wₗ)×Tₗ×cₗ and applying temporal attention to generate processed pooled tokens 555. In some embodiments, spatial-temporal Mamba module 514 includes one or more Mamba layers. In some embodiments, the spatial-temporal Mamba module 514 uses either Mamba-1 or Mamba-2 architectures. In some examples, spatial-temporal Mamba module 514 includes three stacked spatial Mamba layers followed by three temporal Mamba layers.

At step 1006, patchify module 515 generates third patched tokens 556 based on processed pooled tokens 555. In some embodiments, patchify module 515 reduces the spatial and temporal dimensions of processed pooled tokens 555. In some embodiments, patchify module 515 includes a reshape layer that rearranges the input processed pooled tokens 555 into a sequence of spatiotemporal patches and an embedding layer that computes a feature representation for each patch included in third patched tokens 556. At each level l∈[1, L], patchify module 515 downsamples the input processed pooled tokens 555 using a spatiotemporal kernel of size tₗ×hₗ×wₗ. The hierarchical patchification is applied recursively across L levels of encoder 425. As a result, third patched tokens 556 has a compacted dimension of T/t×H/h×W/w×c. In some embodiments, the embedding layer included in patchify module 515 uses linear or 3D convolutional layers. For example, a 3D convolutional layer included in patchify module 515 can apply a kernel of size 2×1×1 across non-overlapping windows of processed pooled tokens 555.

At step 1007, token pooling module 516 generates second pooled tokens 557 based on third patched tokens 556 and processed pooled tokens 555. In some embodiments, token pooling module 516 facilitates hierarchical encoding in the encoder 425 by introducing skip connections between encoder blocks. Let vₗ denote the encoded tokens at encoder level l, such as third patched tokens 556. To combine information across levels, the output tokens, such as second pooled tokens 555, v₁₋₁ from the previous level are downsampled using 3D average pooling with a kernel size of tₗ×hₗ×wₗ, where tₗ, hₗ, and wₗ represent the temporal and spatial kernel sizes at level l. The downsampled tokens are then added to the corresponding tokens vₗ, such as third patched tokens 556, to form a residual connection that results in second pooled tokens 557. The residual skip connections help preserve higher-level semantic information across levels and support coarse-to-fine representation learning for video encoding.

At step 1008, spatial-temporal Mamba module 517 generates latent embeddings 503 based on second pooled tokens 557. In some embodiments, spatial-temporal Mamba module 517 receives second pooled tokens 557 of size b×Tₗ×Hₗ×Wₗ×cₗ. In some embodiments, spatial-temporal Mamba module 517 first applies spatial reasoning by reshaping the token volume into shape (b·Tₗ)×(Hₗ·Wₗ)×cₗ and passing the result to a spatial attention mechanism. The output is then temporally processed by rearranging the tokens into shape (b·Hₗ·Wₗ)×Tₗ×cₗ and applying temporal attention to generate latent embedding 503. In some embodiments, spatial-temporal Mamba module 517 includes one or more Mamba layers. In some embodiments, the spatial-temporal Mamba module 517 uses either Mamba-1 or Mamba-2 architectures. In some examples, spatial-temporal Mamba module 517 includes four stacked spatial Mamba layers followed by four temporal Mamba layers.

FIG. 11 is a flow diagram of method steps for generating quantized latent embeddings 504 based on latent embeddings 503, according to various embodiments. Although the method steps are described in conjunction with the systems of FIGS. 1-8, persons skilled in the art will understand that any system configured to perform the method steps in any order falls within the scope of the present disclosure.

As shown, step 903 begins at step 1101, where channel splitting module 601 generates channel groups 604 based on latent embeddings 503. In some embodiments, channel splitting module 601 first increases the channel size of each latent embedding 503 by a factor of K, such that the updated channel dimension becomes c·K, where c is the original number of channels in the latent embedding 503 and K is a predefined channel expansion factor. In some embodiments, channel splitting module 601 first increases the channel dimension c to c·K, then divided into K groups: v={v₁, v₂, . . . , v_{K}}, where each group vₖ∈ [symbol] . In some examples, the channel expansion is performed using a 1×1×1 convolutional layer that maps the latent embedding 503 to a higher-dimensional space. Each channel group vₖ can be subsequently routed to a separate quantization stream, enabling independent processing by downstream quantizers included in quantization module 602. In some embodiments, channel splitting module 601 omits the initial channel expansion and instead partition the original latent embedding v∈ [symbol] directly into K groups of equal or variable channel width to reduce computational overhead, which is beneficial in lightweight or low-latency deployment scenarios. In some embodiments, channel splitting module 601 includes channel-wise attention or learned gating mechanisms to dynamically determine how the input channels included in latent embedding 503 are grouped.

At step 1102, quantization module 602 generates quantized groups 605 based on channel groups 604. In some embodiments, quantization module 602 quantizes each group vₖ ∈ [symbol] included in channel groups 604 independently. In some embodiments, quantization module 602 applies CSLFQ to each group, for example, as described in Equation 1. The quantized output \hat{v} included in quantized groups 605 is then used as the discrete token. Since the values are binary, CS-LFQ is computationally efficient but has limited representational power compared to VQ. In some embodiments, quantization module 602 uses CS-FSQ, where each group vₖ is first passed through a nonlinear activation function as described in Equation 2. In some embodiments, quantization module 602 applies a hybrid or learned selection strategy, dynamically choosing LFQ or FSQ per group included in channel groups 604 based on reconstruction error, entropy regularization, or visual fidelity requirements.

At step 1103, concatenation module 603 generates quantized latent embeddings 504 based on quantized groups 605. In some embodiments, concatenation module 603 concatenates quantized groups 605 \hat{v}₁, . . . , \hat{v}_{K} along the channel dimension to generate the complete quantized latent embeddings 504 \hat{v}, for example, as described by Equation 3. In some embodiments, to preserve the total number of quantized latent embeddings 504 when the channel size is increased by a factor of K, the spatio-temporal compression rate of encoder 425 is increased proportionally by K. Specifically, for input video frames 501 V with shape T×H×W×3, and spatio-temporal downsampling of t×h×w, the number of quantized latent embeddings 504 is

$$\frac{THW}{thw} .$$

After increasing the channel size by K, the sequence length remains constant by adjusting the compression rate to thw·K, leading to the number of quantized latent embeddings 504 being

$$\frac{H W T}{thw \cdot K} .$$

FIG. 12 is a flow diagram of method steps for generating reconstructing video frames 503 based on quantized latent embeddings 504, according to various embodiments. Although the method steps are described in conjunction with the systems of FIGS. 1-8, persons skilled in the art will understand that any system configured to perform the method steps in any order falls within the scope of the present disclosure.

As shown, step 904 begins at step 1201, where temporal-spatial Mamba module 520 generates first processed tokens 561 based on quantized latent embeddings 504. In some embodiments, input quantized latent embeddings 504 include quantized latent embeddings with shape [symbol] ∈ [symbol] where b is the batch size, T is the number of frames, H×W is the spatial resolution of each frame, and c is the number of channels. Temporal-spatial Mamba module 520 first applies temporal Mamba layers by reshaping the input to [symbol] ∈ [symbol] and applying recurrent-style linear attention across the time dimension to model motion dynamics. The output is then reshaped to [symbol] ∈ [symbol] and spatial Mamba layers are applied to capture per-frame spatial relationships generating first processed token 561 with the shape [symbol] . In some example, temporal-spatial Mamba module 520 include four temporal Mamba layers followed by four spatial Mamba layers.

At step 1202, topixel module 521 generates first grid-like tokens 562 based on first processed tokens 561. In some embodiments, topixel module 521 increases the spatial and temporal dimensions of a given token volume, such as first processed tokens 561. In some embodiments, topixel module 521 includes an embedding layer that uses 3D convolution to project the channel dimension of each token included in first processed tokens 561 to a desired size, followed by a pixelshuffle layer that rearranges the projected tokens into an upsampled spatio-temporal grid included in first grid-like tokens 562. For example, given token input, such as first processed tokens 561, of shape [symbol] ∈ [symbol] the embedding layer projects the token input to a higher channel dimension, and the pixelshuffle operation rearranges the data to [symbol] where tₗ×hₗ×wₗ denotes the spatio-temporal upsampling factor at decoder level I mirroring the downsampling kernel used in the corresponding patchify module included in encoder 425. In some examples, topixel module 521 includes an upsampling kernel of 2×1×1 which uses a pixelshuffle operation to double the temporal resolution of the tokens while keeping the spatial resolution unchanged.

At step 1203, token interpolation module 522 generates first interpolated tokens 563 based on first grid-like tokens 562 and first processed tokens 561. In some embodiments, token interpolation module 522 implements skip connections between different decoder blocks to improve the reconstruction quality of the decoded video. Given decoded tokens \hat{v}ₗ₊₁ from a deeper decoder block, such as first grid-like tokens 562, and skip-connected tokens \hat{v}ₗ from an earlier encoder layer, such as first processed tokens 561, token interpolation module 522 upsamples \hat{v}ₗ₊₁ using nearest-neighbor interpolation in the temporal and spatial dimensions to match the resolution of \hat{v}ₗ, to generate upsampled tokens

$${\hat{v}}_{l + 1}^{↑} .$$

The unsampled tokens

$${\hat{v}}_{l + 1}^{↑}$$

are then added elementwise to \hat{v}ₗ, such as first processed tokens 561, to obtain the interpolated tokens, such as first interpolated tokens 561,

$${\hat{v}}_{l}^{interp} = {\hat{v}}_{l} + {\hat{v}}_{l + 1}^{↑} .$$

At step 1204, temporal-spatial Mamba module 523 generates second processed tokens 564 based on first interpolated tokens 563. In some embodiments, input first interpolated tokens 563 include tokens with shape [symbol] ∈ [symbol] where b is the batch size, T is the number of frames, H×W is the spatial resolution of each frame, and c is the number of channels. Temporal-spatial Mamba module 523 first applies temporal Mamba layers by reshaping the input to [symbol] ∈ [symbol] and applying recurrent-style linear attention across the time dimension to model motion dynamics. The output is then reshaped to [symbol] ∈ [symbol] and spatial Mamba layers are applied to capture per-frame spatial relationships generating second processed token 564 with the shape [symbol] . In some example, temporal-spatial Mamba module 520 include three temporal Mamba layers followed by three spatial Mamba layers.

At step 1205, topixel module 524 generates second grid-like tokens 565 based on second processed tokens 564. In some embodiments, topixel module 524 increases the spatial and temporal dimensions of a given token volume, such as second processed tokens 564. In some embodiments, topixel module 524 includes an embedding layer that uses 3D convolution to project the channel dimension of each token included in second processed tokens 564 to a desired size, followed by a pixelshuffle layer that rearranges the projected tokens into an upsampled spatio-temporal grid included in second grid-like tokens 565. In some examples, topixel module 521 includes an upsampling kernel of 2×2×2 which uses a pixelshuffle operation to double both the temporal and spatial resolution of second processed tokens 564.

At step 1206, token interpolation module 525 generates second interpolated tokens 566 based on second grid-like tokens 565 and second processed tokens 564. In some embodiments, token interpolation module 525 implements skip connections between different decoder blocks to improve the reconstruction quality of the decoded video. Given decoded tokens \hat{v}ₗ₊₁ from a deeper decoder block, such as second processed tokens 564, and skip-connected tokens \hat{v}ₗ from an earlier encoder layer, such as second processed tokens 564, token interpolation module 525 upsamples \hat{v}ₗ₊₁ using nearest-neighbor interpolation in the temporal and spatial dimensions to match the resolution of \hat{v}ₗ, to generate upsampled tokens

$${\hat{v}}_{l + 1}^{↑} .$$

The unsampled tokens

$${\hat{v}}_{l + 1}^{↑}$$

are then added elementwise to \hat{v}ₗ, such as second processed tokens 564, to obtain the interpolated tokens, such as second interpolated tokens 566,

$${\hat{v}}_{l}^{interp} = {\hat{v}}_{l} + {\hat{v}}_{l + 1}^{↑} .$$

At step 1207, temporal-spatial Mamba module 526 generates third processed tokens 567 based on second interpolated tokens 566. In some embodiments, input second interpolated tokens 566 include tokens with shape [symbol] ∈ [symbol] where b is the batch size, T is the number of frames, H×W is the spatial resolution of each frame, and c is the number of channels. Temporal-spatial Mamba module 526 first applies temporal Mamba layers by reshaping the input to [symbol] ∈ [symbol] and applying recurrent-style linear attention across the time dimension to model motion dynamics. The output is then reshaped to [symbol] ∈ [symbol] and spatial Mamba layers are applied to capture per-frame spatial relationships generating third processed token 567 with the shape [symbol] . In some example, temporal-spatial Mamba module 526 include two temporal Mamba layers followed by two spatial Mamba layers.

At step 1208, topixel module 527 generates reconstructed video frames 502 based on third processed tokens 567. In some embodiments, topixel module 527 increases the spatial and temporal dimensions of a given token volume, such as third processed tokens 567. In some embodiments, topixel module 527 includes an embedding layer that uses 3D convolution to project the channel dimension of each token included in third processed tokens 567 to a desired size, followed by a pixelshuffle layer that rearranges the projected tokens into an upsampled spatio-temporal grid included in third grid-like tokens 567. In some examples, topixel module 527 includes an upsampling kernel of 2×4×4 which uses a pixelshuffle operation to to double the temporal resolution and quadruple the spatial resolution of third processed tokens 567.

FIG. 13 is a flow diagram of method steps for training tokenizer model 424, according to various embodiments. Although the method steps are described in conjunction with the systems of FIGS. 1-8, persons skilled in the art will understand that any system configured to perform the method steps in any order falls within the scope of the present disclosure.

As shown, a method 1300 begins at step 1301 where model trainer 415 is initialized. In some embodiments, model trainer 415 initializes an optimization algorithm, such as Adam or AdamW, a cosine annealing learning rate scheduler, and an initial learning rate in the range of 2×10⁻⁴ to 5×10⁻⁴. In some embodiments, model trainer 415 initializes gradient clipping thresholds and enabling AMP for memory-efficient training. Model trainer 415 also initializes training metadata, including checkpointing intervals and validation schedules. In some embodiments, early stopping criteria are initialized based on validation reconstruction quality, such as halting training if no improvement is observed across 10 evaluation intervals. Additional stopping conditions include reaching a fixed number of training steps (e.g., 500,000), stabilization of token entropy, or convergence of codebook usage statistics.

At step 1302, tokenizer model 424 receives video data 417. Video data 417 includes sequences of temporally ordered image or video frames representing visual content over time, such as raw or encoded video clips. Video data 417 includes video frames from real-world footage, simulated environments, or user-generated content, and includes annotations or metadata for conditioning or evaluation purposes.

At step 1303, tokenizer model 424 generates reconstructed video frames 702 based on video data 417. In some embodiments, tokenizer model 424 includes, without limitation, encoder 425, quantizer 426, and decoder 427. In operation, encoder 425 processes ground-truth video frames 701 included in video data 417 and generates latent embeddings 503. Quantizer 426 processes latent embeddings 503 and generates quantized latent embeddings 504. Decoder 427 processes quantized latent embeddings 504 and generates reconstructed video frames 702.

At step 1304, loss calculator 416 calculates loss 703 based on ground-truth video frames 701 and reconstructed video frames 702. In some embodiments, loss calculator 416 uses a combination of loss functions, including but not limited to (i) a reconstruction loss that minimizes the L1 (Manhattan distance) between corresponding pixels of the ground-truth video frames and the reconstructed video frames, (ii) a perceptual loss that computes frame-wise perceptual similarity using the LPIPS metric between the ground-truth video frames and the reconstructed video frames, and/or (iii) a GAN loss that uses a 3D convolutional PatchGAN discriminator to differentiate real videos from generated reconstructed video frames. In some embodiments, for certain tokenization strategies included in quantizer 426, such as LFQ, loss calculator 416 includes entropy penalties and commitment losses. In some embodiments, whenever quantizer 426 includes FSQ, loss calculator 416 bypasses explicit codebook loss computation.

At step 1305, model trainer 415 updates the parameters of tokenizer model 424 based on loss 703. In some embodiments, model trainer 415 uses various optimization algorithms, such as Adam, AdamW with a cosine annealing learning rate schedule, and/or the like. In some embodiments, model trainer 415 begins the training with a linear warm-up phase over a fixed number of steps (e.g., 10,000 steps) to stabilize early learning dynamics. In some examples, model trainer 415 uses an initial learning rate in the range of 2×10⁻⁴ to 5×10⁻⁴, depending on the architecture of tokenizer model 424 and dataset size of video data 417. In some embodiments, model trainer 415 uses gradient clipping to maintain numerical stability and prevent exploding gradients, especially when training with deep recurrent attention modules, such as Mamba. In some examples, model trainer 415 uses mixed-precision training using AMP to improve training throughput and reduce GPU memory consumption.

At step 1306, model trainer 415 determines whether to continue training. In some embodiments, model trainer 415 uses one or more checkpointing and early stopping criteria based on a validation set included in video data 417. In some embodiments, model trainer 415 stops training after a fixed number of steps (e.g., 500,000) or when the validation reconstruction quality does not improve for a predefined number of evaluation intervals (e.g., no improvement in 10 consecutive checkpoints). Additional stopping criteria include convergence of codebook usage statistics or token entropy reaching a stable threshold. In some embodiments, model trainer 415 maintains EMA of the parameters of tokenizer model 415 to stabilize training and improve final evaluation performance. Whenever model trainer 415 determines to continue training, the method 1300 returns to step 1302. Whenever model trainer 415 determines not to continue training, the method 1300 proceeds to step 1307.

At step 1307, model trainer 415 stores tokenizer model 424. In some embodiments, model trainer 415 stores the trained tokenizer model 424 in data store 420 or elsewhere.

FIG. 14 is a flow diagram of method steps for generating generated video frames 803, according to various embodiments. Although the method steps are described in conjunction with the systems of FIGS. 1-8, persons skilled in the art will understand that any system configured to perform the method steps in any order falls within the scope of the present disclosure.

As shown, a method 1400 begins at step 1401, where video generation application 446 receives conditions 802. In some embodiments, video generation application receives conditions 802 from one or more I/O devices.

At step 1402, video token generator 801 generates video tokens based on conditions 802. In some embodiments, video generation application 446 includes a pre-trained video token generator, such as an autoregressive transformer or a diffusion-based sampler, that processes conditions 802 and generates one or more video tokens (e.g., latent embeddings 503).

At step 1403, video generation application 446 generates generated video frames 803, using the trained tokenizer model 424, based on video tokens. In some embodiments, video generation application 446 uses quantizer 426 included in trained tokenizer model 424 to process each latent embedding 503 and maps each latent embedding 503 to a corresponding quantized latent embedding 504 in a learned latent space, translating symbolic representations into compressed spatiotemporal features. Decoder 427 then processes the sequence of quantized latent embeddings 504 to generate reconstructed video frames 502. Video generation application 446 processes reconstructed video frames 502 and generates generated video frames 803. In some embodiments, video generation application 446 applies one or more post-processing operations such as temporal smoothing, frame alignment, or resolution adjustment, and composes reconstructed video frames 502 into a continuous video stream included in generated video frames 803.

In sum, techniques are disclosed for video tokenization using channel-split quantization and mamba-based tokenizer models. In some embodiments, disclosed techniques include a tokenizer model. The tokenizer model is a machine learning model, such as a neural network, which processes one or more video frames and generates reconstructed video frames. The tokenizer model includes an encoder, a quantizer, and a decoder. The encoder is a machine learning model, such as a neural network, which processes the video frames and generates one or more latent embeddings. The encoder includes a multi-layer hierarchical architecture which includes without limitation one or more patchify modules, token pooling modules, and spatial-temporal Mamba modules arranged in an alternating sequence. The encoder progressively processes input video frames into increasingly abstract token representations, applying spatial and temporal attention at multiple scales to capture both local and long-range dependencies. Through the layered composition, the encoder generates latent embeddings that summarize the spatiotemporal content of the input video in a compressed and semantically rich form.

In some embodiments, the quantizer processes the latent embeddings and generates one or more quantized latent embeddings. The decoder is a machine learning model, such as a neural network, which processes the quantized latent embeddings and generates the reconstructed video frames. The decoder includes a multi-stage architecture, which includes without limitation one or more temporal-spatial Mamba modules, topixel modules, and token interpolation modules arranged in sequential layers. The decoder transforms quantized latent embeddings into reconstructed video frames by progressively refining and upsampling intermediate token representations. Each stage applies spatiotemporal processing followed by token-to-grid conversion and resolution enhancement, enabling high-fidelity reconstruction of video content from discrete tokens. In some embodiments, a model trainer trains the tokenizer model based on video data. During training, the tokenizer model processes the video data and generates the reconstructed video frames. A loss calculator calculates a loss based on the reconstructed video frames and one or more ground-truth video frames included in the video data. The model trainer uses the loss to iteratively update the parameters of the tokenizer model until one or more stopping criteria are met. Once the tokenizer model is trained, a video generation application uses the quantizer and the decoder included in the trained tokenizer model to process one or more conditions and generate generated video frames.

In some embodiments, the tokenizer includes a channel-splitting module, a quantization module, and a concatenation module. The channel-splitting module processes the latent embeddings and generates one or more channel groups. The quantization module processes the channel groups and generates one or more quantized groups. The concatenation module processes the quantized groups and generates the quantized latent embeddings.

At least one technical advantage of the disclosed techniques relative to the prior art is that the disclosed techniques improve quantization stability, efficiency, and expressiveness. The disclosed techniques further enable scalable, deterministic tokenization without reliance on a single fixed codebook. In addition, the disclosed techniques provide for more adaptive and context-aware tokenization than prior art methods. The tokens generated by the disclosed techniques also better capture global scene dynamics and long-range motion patterns, supporting efficient and high-fidelity video tokenization over extended temporal spans. These technical advantages provide one or more technological improvements over prior art approaches.
1. In some embodiments, a computer-implemented method for tokenizing video frames comprises receiving one or more video frames from one or more I/O devices, generating, using an encoder, one or more latent embeddings based on the one or more video frames, wherein the encoder comprises one or more patchify modules, one or more spatial-temporal Mamba modules, and one or more token pooling modules, and generating, using a quantizer, one or more quantized latent embeddings based on the one or more latent embeddings.
2. The computer-implemented method of clause 1, wherein generating the one or more latent embeddings comprises generating, using a first patchify module included in the one or more patchify modules based on the one or more video frames, one or more first patched tokens, generating, using a first spatial-temporal Mamba module included in the one or more spatial-temporal Mamba modules, one or more processed patched tokens based on the one or more first patched tokens, generating, using a second patchify module included in the one or more patchify modules, one or more second patched tokens based on the one or more processed patched tokens, and generating, using a first token pooling module included in the one or more token pooling modules, one or more first pooled tokens based on the one or more second patched tokens and the one or more processed patched tokens.
3. The computer-implemented method of clauses 1 or 2, further comprising generating, using a second spatial-temporal Mamba module included in the one or more spatial-temporal Mamba modules, one or more processed pooled tokens based on the one or more first pooled tokens, generating, using a third patchify module included in the one or more patchify modules, one or more third patched tokens based on the one or more processed pooled tokens, generating, using a second token pooling module included in the one or more token pooling modules, one or more second pooled tokens based on the one or more third patched tokens and the one or more processed pooled tokens, and generating, using a third spatial-temporal Mamba module included in the one or more spatial-temporal Mamba modules, the one or more latent embeddings based on the one or more second pooled tokens.
4. The computer-implemented method of any of clauses 1-3, further comprising generating, using a decoder, one or more reconstructed video frames based on the one or more quantized latent embeddings, wherein the decoder comprises one or more temporal-spatial Mamba modules, one or more topixel modules, and one or more token interpolation modules.
5. The computer-implemented method of any of clauses 1-4, wherein at least a first token interpolation module included in the one or more token interpolation modules performs a nearest-neighbor interpolation in one or more temporal and spatial dimensions to match a resolution of one or more processed tokens to generate one or more upsampled tokens, and elementwise adding of the one or more upsampled tokens and the one or more processed tokens to generate one or more interpolated tokens.
6. The computer-implemented method of any of clauses 1-5, wherein generating the one or more reconstructed video frames comprises generating, using a first temporal-spatial Mamba module included in the one or more temporal-spatial Mamba modules, one or more first processed tokens based on the one or more quantized latent embeddings, generating, using a first embedding layer included in a first topixel module included in the one or more topixel modules, one or more first projected tokens based on the one or more first processed tokens, generating, using a first pixelshuffle layer included in the first topixel module included in the one or more topixel modules, one or more first grid-like tokens based on the first projected tokens, generating, using a first token interpolation module included in the one or more token interpolation modules, one or more first interpolated tokens based on the one or more first grid-like tokens and the one or more first processed tokens, and generating, using a second temporal-spatial Mamba module included in the one or more temporal-spatial Mamba modules, one or more second processed tokens based on the one or more first interpolated tokens.
7. The computer-implemented method of any of clauses 1-6, further comprising generating, using a second embedding layer included in a second topixel module included in the one or more topixel modules, one or more second projected tokens based on the one or more second processed tokens, generating, using a second pixelshuffle layer included in the second topixel module included in the one or more topixel modules, one or more second grid-like tokens based on the second projected tokens, generating, using a second token interpolation module included in the one or more token interpolation modules, one or more second interpolated tokens based on the one or more second grid-like tokens and the one or more second processed tokens, generating, using a third temporal-spatial Mamba module included in the one or more temporal-spatial Mamba modules, one or more third processed tokens based on the one or more second interpolated tokens, and generating, using a third topixel module included in the one or more third topixel modules, the one or more reconstructed video frames based on the one or more third processed tokens.
8. The computer-implemented method of any of clauses 1-7, wherein a first patchify module included in the one or more patchify modules comprises at least one of a reshape layer or an embedding layer.
9. The computer-implemented method of any of clauses 1-8, wherein a 3D convolutional layer included in the first patchify module applies a kernel of fixed size across one or more non-overlapping windows of one or more processed pooled tokens to generate one or more patched tokens.
10. The computer-implemented method of any of clauses 1-9, wherein a first token pooling module included in the one or more token pooling modules performs downsampling of one or more processed patched tokens using 3D average pooling with a fixed kernel size to generate one or more downsampled tokens, and adding the one or more downsampled tokens and one or more patched tokens to generate one or more pooled tokens.
11. The computer-implemented method of any of clauses 1-10, wherein a first spatial-temporal Mamba module included in the one or more spatial-temporal Mamba modules comprises a first number of one or more stacked spatial Mamba layers followed by the first number of one or more temporal Mamba layers.
12. In some embodiments, one or more non-transitory computer-readable media store instructions that, when executed by one or more processors, cause the one or more processors to perform the steps of receiving one or more video frames from one or more I/O devices, generating, using an encoder, one or more latent embeddings, wherein the encoder comprises one or more patchify modules, one or more spatial-temporal Mamba modules, and one or more token pooling modules based on the one or more video frames, and generating, using a quantizer, one or more quantized latent embeddings based on the one or more latent embeddings.
13. The one or more non-transitory computer-readable media of clause 12, wherein generating the one or more latent embeddings comprises generating, using a first patchify module included in the one or more patchify modules, one or more first patched tokens based on the one or more video frames, generating, using a first spatial-temporal Mamba module included in the one or more spatial-temporal Mamba modules, one or more processed patched tokens based on the one or more first patched tokens, generating, using a second patchify module included in the one or more patchify modules, one or more second patched tokens based on the one or more processed patched tokens, and generating, using a first token pooling module included in the one or more token pooling modules, one or more first pooled tokens based on the one or more second patched tokens and the one or more processed patched tokens.
14. The one or more non-transitory computer-readable media of clauses 12 or 13, wherein the instructions, when executed by the one or more processors, further cause the one or more processors to perform the steps of generating, using a second spatial-temporal Mamba module included in the one or more spatial-temporal Mamba modules, one or more processed pooled tokens based on the one or more first pooled tokens, generating, using a third patchify module included in the one or more patchify modules, one or more third patched tokens based on the one or more processed pooled tokens, generating, using a second token pooling module included in the one or more token pooling modules, one or more second pooled tokens based on the one or more third patched tokens and the one or more processed pooled tokens, and generating, using a third spatial-temporal Mamba module included in the one or more spatial-temporal Mamba modules, the one or more latent embeddings based on the one or more second pooled tokens.
15. The one or more non-transitory computer-readable media of any of clauses 12-14, wherein a first patchify module included in the one or more patchify modules comprises at least one of a reshape layer or an embedding layer.
16. The one or more non-transitory computer-readable media of any of clauses 12-15, wherein a first token pooling module included in the one or more token pooling modules performs downsampling of one or more processed patched tokens using 3D average pooling with a fixed kernel size to generate one or more downsampled tokens, and adding the one or more downsampled tokens and one or more patched tokens to generate one or more pooled tokens.
17. The one or more non-transitory computer-readable media of any of clauses 12-16, wherein a first spatial-temporal Mamba module included in the one or more spatial-temporal Mamba modules comprises a first number of one or more temporal Mamba layers followed by the first number of one or more spatial Mamba layers.
18. The one or more non-transitory computer-readable media of any of clauses 12-17, wherein the instructions, when executed by the one or more processors, further cause the one or more processors to perform the step of generating, using a decoder, one or more reconstructed video frames based on the one or more quantized latent embeddings, wherein the decoder comprises one or more temporal-spatial Mamba modules, one or more topixel modules, and one or more token interpolation modules.
19. The one or more non-transitory computer-readable media of any of clauses 12-18, wherein at least a first token interpolation module included in the one or more token interpolation modules performs a nearest-neighbor interpolation in one or more temporal and spatial dimensions to match a resolution of one or more processed tokens to generate one or more upsampled tokens, and elementwise adding of the one or more upsampled tokens and the one or more processed tokens to generate one or more interpolated tokens.
20. In some embodiments, a system comprises one or more memories storing instructions, and one or more processors that are coupled to the one or more memories and, when executing the instructions, are configured to receive one or more video frames from one or more I/O devices, generate, using an encoder, one or more latent embeddings based on the one or more video frames, wherein the encoder comprises one or more patchify modules, one or more spatial-temporal Mamba modules, and one or more token pooling modules, and generate, using a quantizer, one or more quantized latent embeddings based on the one or more latent embeddings.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for tokenizing video frames, the method comprising:
receiving one or more video frames from one or more I/O devices;
generating, using an encoder, one or more latent embeddings based on the one or more video frames, wherein the encoder comprises one or more patchify modules, one or more spatial-temporal Mamba modules, and one or more token pooling modules; and
generating, using a quantizer, one or more quantized latent embeddings based on the one or more latent embeddings.

2. The computer-implemented method of claim 1, wherein generating the one or more latent embeddings comprises:
generating, using a first patchify module included in the one or more patchify modules based on the one or more video frames, one or more first patched tokens;
generating, using a first spatial-temporal Mamba module included in the one or more spatial-temporal Mamba modules, one or more processed patched tokens based on the one or more first patched tokens;
generating, using a second patchify module included in the one or more patchify modules, one or more second patched tokens based on the one or more processed patched tokens; and
generating, using a first token pooling module included in the one or more token pooling modules, one or more first pooled tokens based on the one or more second patched tokens and the one or more processed patched tokens.

3. The computer-implemented method of claim 2, further comprising:
generating, using a second spatial-temporal Mamba module included in the one or more spatial-temporal Mamba modules, one or more processed pooled tokens based on the one or more first pooled tokens;
generating, using a third patchify module included in the one or more patchify modules, one or more third patched tokens based on the one or more processed pooled tokens;
generating, using a second token pooling module included in the one or more token pooling modules, one or more second pooled tokens based on the one or more third patched tokens and the one or more processed pooled tokens; and
generating, using a third spatial-temporal Mamba module included in the one or more spatial-temporal Mamba modules, the one or more latent embeddings based on the one or more second pooled tokens.

4. The computer-implemented method of claim 1, further comprising:
generating, using a decoder, one or more reconstructed video frames based on the one or more quantized latent embeddings, wherein the decoder comprises one or more temporal-spatial Mamba modules, one or more topixel modules, and one or more token interpolation modules.

5. The computer-implemented method of claim 4, wherein at least a first token interpolation module included in the one or more token interpolation modules performs:
a nearest-neighbor interpolation in one or more temporal and spatial dimensions to match a resolution of one or more processed tokens to generate one or more upsampled tokens; and
elementwise adding of the one or more upsampled tokens and the one or more processed tokens to generate one or more interpolated tokens.

6. The computer-implemented method of claim 4, wherein generating the one or more reconstructed video frames comprises:
generating, using a first temporal-spatial Mamba module included in the one or more temporal-spatial Mamba modules, one or more first processed tokens based on the one or more quantized latent embeddings;
generating, using a first embedding layer included in a first topixel module included in the one or more topixel modules, one or more first projected tokens based on the one or more first processed tokens;
generating, using a first pixelshuffle layer included in the first topixel module included in the one or more topixel modules, one or more first grid-like tokens based on the first projected tokens;
generating, using a first token interpolation module included in the one or more token interpolation modules, one or more first interpolated tokens based on the one or more first grid-like tokens and the one or more first processed tokens; and
generating, using a second temporal-spatial Mamba module included in the one or more temporal-spatial Mamba modules, one or more second processed tokens based on the one or more first interpolated tokens.

7. The computer-implemented method of claim 6, further comprising:
generating, using a second embedding layer included in a second topixel module included in the one or more topixel modules, one or more second projected tokens based on the one or more second processed tokens;
generating, using a second pixelshuffle layer included in the second topixel module included in the one or more topixel modules, one or more second grid-like tokens based on the second projected tokens;
generating, using a second token interpolation module included in the one or more token interpolation modules, one or more second interpolated tokens based on the one or more second grid-like tokens and the one or more second processed tokens;
generating, using a third temporal-spatial Mamba module included in the one or more temporal-spatial Mamba modules, one or more third processed tokens based on the one or more second interpolated tokens; and
generating, using a third topixel module included in the one or more third topixel modules, the one or more reconstructed video frames based on the one or more third processed tokens.

8. The computer-implemented method of claim 1, wherein a first patchify module included in the one or more patchify modules comprises at least one of a reshape layer or an embedding layer.

9. The computer-implemented method of claim 8, wherein a 3D convolutional layer included in the first patchify module applies a kernel of fixed size across one or more non-overlapping windows of one or more processed pooled tokens to generate one or more patched tokens.

10. The computer-implemented method of claim 1, wherein a first token pooling module included in the one or more token pooling modules performs
downsampling of one or more processed patched tokens using 3D average pooling with a fixed kernel size to generate one or more downsampled tokens; and
adding the one or more downsampled tokens and one or more patched tokens to generate one or more pooled tokens.

11. The computer-implemented method of claim 1, wherein a first spatial-temporal Mamba module included in the one or more spatial-temporal Mamba modules comprises a first number of one or more stacked spatial Mamba layers followed by the first number of one or more temporal Mamba layers.

12. One or more non-transitory computer-readable media storing instructions that, when executed by one or more processors, cause the one or more processors to perform the steps of:
receiving one or more video frames from one or more I/O devices;
generating, using an encoder, one or more latent embeddings, wherein the encoder comprises one or more patchify modules, one or more spatial-temporal Mamba modules, and one or more token pooling modules based on the one or more video frames; and
generating, using a quantizer, one or more quantized latent embeddings based on the one or more latent embeddings.

13. The one or more non-transitory computer-readable media of claim 12, wherein generating the one or more latent embeddings comprises:
generating, using a first patchify module included in the one or more patchify modules, one or more first patched tokens based on the one or more video frames;
generating, using a first spatial-temporal Mamba module included in the one or more spatial-temporal Mamba modules, one or more processed patched tokens based on the one or more first patched tokens;
generating, using a second patchify module included in the one or more patchify modules, one or more second patched tokens based on the one or more processed patched tokens; and
generating, using a first token pooling module included in the one or more token pooling modules, one or more first pooled tokens based on the one or more second patched tokens and the one or more processed patched tokens.

14. The one or more non-transitory computer-readable media of claim 13, wherein the instructions, when executed by the one or more processors, further cause the one or more processors to perform the steps of:
generating, using a second spatial-temporal Mamba module included in the one or more spatial-temporal Mamba modules, one or more processed pooled tokens based on the one or more first pooled tokens;
generating, using a third patchify module included in the one or more patchify modules, one or more third patched tokens based on the one or more processed pooled tokens;
generating, using a second token pooling module included in the one or more token pooling modules, one or more second pooled tokens based on the one or more third patched tokens and the one or more processed pooled tokens; and
generating, using a third spatial-temporal Mamba module included in the one or more spatial-temporal Mamba modules, the one or more latent embeddings based on the one or more second pooled tokens.

15. The one or more non-transitory computer-readable media of claim 12, wherein a first patchify module included in the one or more patchify modules comprises at least one of a reshape layer or an embedding layer.

16. The one or more non-transitory computer-readable media of claim 12, wherein a first token pooling module included in the one or more token pooling modules performs:
downsampling of one or more processed patched tokens using 3D average pooling with a fixed kernel size to generate one or more downsampled tokens; and
adding the one or more downsampled tokens and one or more patched tokens to generate one or more pooled tokens.

17. The one or more non-transitory computer-readable media of claim 12, wherein a first spatial-temporal Mamba module included in the one or more spatial-temporal Mamba modules comprises a first number of one or more temporal Mamba layers followed by the first number of one or more spatial Mamba layers.

18. The one or more non-transitory computer-readable media of claim 12, wherein the instructions, when executed by the one or more processors, further cause the one or more processors to perform the step of:
generating, using a decoder, one or more reconstructed video frames based on the one or more quantized latent embeddings, wherein the decoder comprises one or more temporal-spatial Mamba modules, one or more topixel modules, and one or more token interpolation modules.

19. The one or more non-transitory computer-readable media of claim 18, wherein at least a first token interpolation module included in the one or more token interpolation modules performs:
a nearest-neighbor interpolation in one or more temporal and spatial dimensions to match a resolution of one or more processed tokens to generate one or more upsampled tokens; and
elementwise adding of the one or more upsampled tokens and the one or more processed tokens to generate one or more interpolated tokens.

20. A system, comprising:
one or more memories storing instructions, and
one or more processors that are coupled to the one or more memories and, when executing the instructions, are configured to:
receive one or more video frames from one or more I/O devices;
generate, using an encoder, one or more latent embeddings based on the one or more video frames, wherein the encoder comprises one or more patchify modules, one or more spatial-temporal Mamba modules, and one or more token pooling modules, and
generate, using a quantizer, one or more quantized latent embeddings based on the one or more latent embeddings.
